(19) United States
(12) Patent Application Publication
(10) Pub. No.: US 2018/0222566 A1
(43) Pub. Date: Aug. 9, 2018

(54) BALLAST WATER TREATMENT APPARATUS

(71) Applicant: Ballast Water Containers Limited, Glasgow (GB)

(72) Inventors: Christopher Thomas MCMENEMY, Glasgow (GB); John Angus MACSWEEN, Glasgow (GB)

(21) Appl. No.: 15/748,186

(22) PCT Filed: Jul. 28, 2016
(86) PCT No.: PCT/GB2016/052322

§ 371 Date: Jan. 27, 2018

(30) Foreign Application Priority Data
Jul. 28, 2015 (GB) 1513302.8
May 6, 2016 (GB) 1607932.9

(51) Int. Cl. B63J 4/00; C02F 1/00; C02F 1/32; C02F 1/36; C02F 1/467; C02F 1/78; C02F 9/00

(52) U.S. Cl. CPC B63J 4/002; C02F 1/004; C02F 1/32; C02F 2103/008; C02F 1/4674; C02F 1/78; C02F 9/00; C02F 1/36

(57) ABSTRACT

An apparatus for treating ballast water comprising a ballast water inlet, a treated ballast water outlet, a filter and a water treatment unit, the filter and the water treatment unit being arranged sequentially between the ballast water inlet and the ballast water outlet; and a further comprising a water monitoring unit, the water monitoring unit being operable to monitor at least one parameter of the water passing through the apparatus.

### FIELD OF THE INVENTION

This invention relates to a method and apparatus for the treatment of ships' ballast water.

### BACKGROUND TO THE INVENTION

It is usual for ships which are less than fully loaded to take water into ballast tanks to achieve the desired draught and trim. Until recently, ballast water was simply pumped in from the sea when required, and discharged overboard when no longer required. This procedure has ecological implications, as it causes marine organisms and bacteria to be introduced into marine environments where they were not previously present.

The International Maritime Organisation (IMO) has established a convention (the International Convention for Control and Management of Ships' Ballast Water and Sediments) to address this problem; similar provisions apply in US waters under United States Coast Guard regulations. The IMO Convention has a requirement, the D-2 requirement, which imposes strict limits on aquatic organisms which can be discharged:
Plankton, >50 μm min dimension <10 cells/m³
Plankton, 10-50 μm <10 cells/ml
Toxicogenic Vibrio cholera (O1 and O139) <1 cfu*/100 ml
Eschericia coli <250 cfu*/100 ml
Intestinal enterococci <100 cfu*/100 ml *colony forming unit

It is known to meet the requirements of this legislation by a combination of filtering and ultraviolet treatment. Typically, a two-pass approach is used in which water is filtered and UV treated when it is loaded into the ballast tanks, and UV treatment only is used when discharging. Ships have been modified to provide such treatment on-board by the permanent installation of appropriate filters and UV treatment units together with associated pumps, pipework and valves. Such an installation is expensive and takes up space on the ship.

One area to which the present invention is particularly (but not exclusively) applicable is that of heavy lift vessels which are typically used to transport large indivisible loads. Such vessels typically undertake long voyages with a single cargo/load, and thus take on and discharge ballast water only a few times per year. It would be uneconomical to equip these vessels with permanent treatment plant. Indeed, many heavy lift vessels have no permanent ballast water handling system, and portable pumps are used to take on and discharge ballast water through deck hatches/manholes.

It is therefore desirable to provide a readily transportable apparatus for treating ballast water which can be taken to a vessel for either loading or discharging ballast water.

It has been proposed to provide a ballast water treatment plant in containerised form; see Damen “InvaSave” at www.damen.com. This known plant has the drawbacks that it requires a 40 foot container, and it has no means for continuously monitoring water quality to give on-site indication of correct treatment or data logging.

It is usual for the filter in a treatment plant to be cleaned by backflushing when the pressure drop becomes unacceptably high. The debris from the backflushing operation is normally discharged overboard. This is acceptable at the location where water is taken on. However, where the ballast water is not treated at the loading location, it would be unacceptable to discharge the backflush mixture at the destination, as this would lead to untreated material being discharged. It would be desirable to provide a convenient means to avoid this.

According to a first aspect of the present invention there is provided an apparatus for treating ballast water comprising:
a ballast water inlet;
a treated ballast water outlet;
a filter;
a water treatment unit, wherein the filter and the water treatment unit are arranged sequentially between the ballast water inlet and the ballast water outlet; and
a water monitoring unit, the water monitoring unit being operable to monitor at least one parameter of the water passing through the apparatus.

The water monitoring unit may be operable to monitor or measure at least one parameter, condition, component or content of the water passing through the apparatus.

The water treatment unit may be operable to kill or render moribund aquatic organisms or species in the ballast water. The water treatment unit may be operable to kill or render moribund aquatic organisms or species in the ballast water in accordance with legislative standards. The legislative standards may be the International Convention for Control and Management of Ships' Ballast Water and Sediments. The legislative standard may be the D-2 requirement established by the International Maritime Organisation (IMO).

The water treatment unit may be an ultraviolet (UV) treatment unit. The water treatment unit may be an electro chlorination treatment unit. The water treatment unit may be an ozone treatment unit. The water treatment unit may be a chemical treatment unit. The water treatment unit may be an ultrasonic treatment unit. The water treatment unit may be a deoxygenation treatment unit. The water treatment unit may include one or more of the water treatment units described above. The water treatment unit may comprise a combination of any two or more of an ultraviolet (UV) treatment unit, an electro chlorination treatment unit, an ozone treatment unit, a chemical treatment unit, an ultrasonic treatment unit and a deoxygenation treatment unit. All of the above water treatment units are operable to kill or render moribund aquatic organisms or species in the ballast water.

The ballast water inlet may be configured to be connectable to a source of ballast water. The source of ballast water may be sea water.

The treated ballast water outlet may be configured to be connectable to a ship's ballast tank, or tanks, or directly overboard.

The filter may be a screen filter. The filter may include a 40 micron filter element. The filter may include a filter element between 30 micron and 40 micron.

The filter may be configured to be operable across an approximate pressure drop of 0.1 to 0.4 bar.

The filter and the water treatment unit may be arranged in series. The filter and the water treatment unit may be arranged such that the water treatment unit is closer to the treated ballast water outlet than the filter. Alternatively, the filter and the water treatment unit may be arranged such that the filter unit is closer to the treated ballast water outlet than the water treatment unit.

The water monitoring unit may be configured and operable to monitor two or more parameters of water passing through the apparatus. The water monitoring unit may be configured and operable to monitor a plurality of parameters of water passing through the apparatus.

The water monitoring unit may be operable to monitor the quality of the water passing through the apparatus. The water monitoring unit may be operable to monitor the contents of the water passing through the apparatus. The water monitoring unit may be operable to monitor the aquatic organism contents of the water passing through the apparatus.

The water monitoring unit may be operable to monitor particle size. The water monitoring unit may be operable to detect the presence of particles. The water monitoring unit may be operable to detect the presence of particles of micro-organisms. The water monitoring unit may be operable to detect the amount of an aquatic organism, or aquatic organisms, present in a particular volume of water.

The water monitoring unit may also include one or more data logging devices operable to store data relating to the monitored parameters.

The water monitoring unit may be operable to compare the at least one monitored parameter with at least one predetermined parameter, or at least one reference parameter. The water monitoring unit may be operable to compare the at least one monitored parameter, or parameters, with at least one predetermined parameter, or parameters. The water monitoring unit may be operable to compare the at least one monitored parameter, or parameters, with at least one reference parameter, or parameters.

The water monitoring unit may be operable to monitor the quality of incoming water. The water monitoring unit may be operable to monitor the quality of treated water. The water monitoring unit may be operable to monitor the quality of both incoming water and treated water.

The water monitoring unit may be operable to sample the treated water. The water monitoring unit may be operable to sample the treated water and compare the at least one monitored parameter with at least one reference parameter. The at least one reference parameter may be a predetermined discharge acceptable standard according to the International Maritime Organisation (IMO) and/or US Coast Guard (USCG).

The water monitoring unit may be operable to provide an indication of the comparison between the at least one monitored parameter with at least one reference parameter. The indication may be a visual indication. The indication may be a visible “pass” or “fail”, depending on how the at least one monitored parameter with at least one reference parameter.

The water monitoring unit may be operable to compare the at least one monitored parameter with at least one reference parameter in real time.

The water monitoring unit may also include one or more data logging devices operable to store data relating to the monitored parameters and the comparison between the at least one reference parameter. The indication of comparison being between the at least one monitored parameter with at least one reference parameter.

The water monitoring unit may be operable to prevent discharge of ballast water if the at least one monitored parameter of the ballast water does not meet pre-determined standards, or certain compliance conditions.

The apparatus may be configured such that ballast water that does not meet pre-determined standards, or certain compliance conditions, is recirculated for retreatment. The ballast water may be recirculated in the apparatus until the ballast water meets pre-determined standards, or certain compliance conditions. In this arrangement the apparatus may include one or more flow paths, or pipework, that redirects ballast water that does not meet pre-determined standards, or certain compliance conditions, back to the ballast tank for retreatment. The apparatus may include a ballast tank return outlet. The ballast tank return outlet being configured to return ballast water that does not meet pre-determined standards, or certain compliance conditions, back to the ballast tank for retreatment.

The water monitoring unit may be based on a single turnover fluorescence (STF) induction method of detection.

The apparatus may include two or more ballast water inlets. The apparatus may include a first ballast water inlet and a second ballast water inlet.

The two or more ballast water inlets may join together downstream of the inlets. The two or more ballast water inlets may join downstream of the inlets to become a single flow path.

Each ballast water inlet may be associated with, or include, a control valve. The control valve may be operable to control the flow rate of water therethrough.

Each ballast water inlet may be associated with, or include, a flow meter. The flow meter may be operable to measure, or determine, the flow rate of water through the inlet and/or control valve. Each flow meter may be located downstream, or upstream, of the control valve. Each flow meter may be operable to control the operation of the control valve. Each flow meter may be operable to control the operation of the control valve such that the flow rates of water passing through each inlet and/or control valve is substantially equal. Each flow meter may be operable to automatically control the operation of the control valve. Each flow meter may be operable to automatically control the operation of the control valve such that the flow rates of water passing through each inlet and/or control valve are substantially equal.

The apparatus may include two or more treated ballast water outlets. The apparatus may include a first treated ballast water outlet and a second treated ballast water outlet.

The two or more treated ballast water outlets may join together upstream of the outlets. The two or more treated ballast water outlets may join upstream of the outlets from a single flow path.

Each treated ballast water outlet may be associated with, or include, a control valve. The control valve may be operable to control the flow rate of water therethrough.

Each treated ballast water outlet may be associated with, or include, a flow meter. The flow meter may be operable to measure, or determine, the flow rate of water through the outlet and/or control valve. Each flow meter may be located downstream, or upstream, of the control valve. Each flow meter may be operable to control the operation of the control valve. Each flow meter may be operable to control the operation of the control valve such that the flow rates of water passing through each outlet and/or control valve is substantially equal. Each flow meter may be operable to automatically control the operation of the control valve. Each flow meter may be operable to automatically control the operation of the control valve such that the flow rates of water passing through each outlet and/or control valve are substantially equal.

The apparatus may include two or more ballast tank return outlets. The apparatus may include a first ballast tank return outlet and a second ballast tank return outlet.

The two or more ballast tank return outlets are associated with the treated ballast water outlets.

Each ballast tank return outlet may be associated with, or include, a control valve. The control valve may be operable to control the flow rate of water therethrough.

Each ballast tank return outlet may be associated with the flow meter of the treated ballast water outlet. The flow meter may be operable to control the operation of the control valves of the treated ballast water outlet and ballast tank return outlet to select where treated water should be dispatched. The flow meter may be operable to measure, or determine, the flow rate of water through the outlet and/or control valve. Each flow meter may be located downstream, or upstream, of the control valve.

Each flow meter may be operable to control the operation of the control valve. Each flow meter may be operable to control the operation of the control valve such that the flow rates of water passing through each outlet and/or control valve is substantially equal. Each flow meter may be operable to automatically control the operation of the control valve. Each flow meter may be operable to automatically control the operation of the control valve such that the flow rates of water passing through each outlet and/or control valve are substantially equal.

The apparatus may further comprise one or more valves which are selectively operable to pass a proportion of incoming water and/or treated water through the water monitoring unit.

The apparatus may further comprise a backflush return outlet.

The apparatus may include one or more filter bypass circuits. The filter bypass circuits being configured to allow incoming water to bypass the filter. The filter may be selectively bypassed to permit water treatment only of previously filtered water.

The apparatus may further comprise a backflush handling system connected to receive backflush liquid from the filter.

The apparatus may further comprise an auxiliary pumping system. The auxiliary pumping system may include a pump (stripping pump) and one or more strainers. Each strainer may be associated with a control valve. The pump may be a diaphragm pump, a low profile “puddle pump” or potentially a submersible pump, or the like.

The apparatus may further comprise an auxiliary pump inlet. The auxiliary pump inlet being configured to be connectable to the auxiliary pumping system. The auxiliary pump inlet may be configured to be connectable to a ballast tank.

The auxiliary pumping system may be configured and operable to remove residual ballast water that cannot otherwise be removed from a ballast tank by pumps normally associated with ships, barges etc.

The apparatus may further comprise a control system. The control system may be operable to control the operation of one or more, or all, of: the water treatment unit; the water monitoring unit; all valves and control valves of the apparatus; the control valves of the ballast water inlets, treated ballast water outlets and ballast return outlets; the flow meters of the ballast water inlets and treated ballast water outlets; the backflush handling system; the auxiliary pumping system and the incoming water analysis unit.

The control system may be located with the apparatus.

The control system may be located remotely from the apparatus. The control system may be configured to operate the apparatus from a remote location. The control system may include a hand-held operating device. The hand-held operating device being configured to control the operation of the apparatus. The hand-held operating device, or control system, may be hard-wired to the apparatus for the operation thereof. The hand-held operating device, or control system, may be configured to operate the apparatus wirelessly. The wireless operation may be of any suitable wireless protocol communication system, including 3G, 4G etc.

According to a second aspect of the present invention there is provided an apparatus for treating ballast water comprising:
a ballast water inlet;
a treated ballast water outlet;
a filter;
a water treatment unit, wherein the filter and the water treatment unit are arranged sequentially between the ballast water inlet and the ballast water outlet; and
a backflush handling system connected to receive backflush liquid from the filter.

The water treatment unit may be operable to kill or render moribund aquatic organisms or species in the ballast water. The water treatment unit may be operable to kill or render moribund aquatic organisms or species in the ballast water in accordance with legislative standards. The legislative standards may be the International Convention for Control and Management of Ships' Ballast Water and Sediments. The legislative standard may be the D-2 requirement established by the International Maritime Organisation (IMO).

The water treatment unit may be an ultraviolet (UV) treatment unit. The water treatment unit may be an electro chlorination treatment unit. The water treatment unit may be an ozone treatment unit. The water treatment unit may be a chemical treatment unit. The water treatment unit may be an ultrasonic treatment unit. The water treatment unit may be a deoxygenation treatment unit. The water treatment unit may include one or more of the water treatment units described above. The water treatment unit may comprise a combination of any two or more of an ultraviolet (UV) treatment unit, an electro chlorination treatment unit, an ozone treatment unit, a chemical treatment unit, an ultrasonic treatment unit and a deoxygenation treatment unit. All of the above water treatment units are operable to kill or render moribund aquatic organisms or species in the ballast water.

The backflush handling system may comprise a backflush treatment apparatus.

The backflush treatment apparatus may comprise a settling tank, a backflush pump and one or more backflush strainers. The settling tank, backflush pump and backflush strainers being operable to separate sediment from the water.

The backflush treatment apparatus may additionally or alternatively comprise at least one centrifugal separator, at least one cyclonic separator or at least one clarifier. The at least one centrifugal separator, at least one cyclonic separator and the at least one clarifier being operable to separate sediment from the water.

The backflush treatment apparatus may be operable to separate sediment from the water and drain the sediment to a sediment storage vessel. The backflush treatment apparatus may be operable to reintroduce the sediment-free water back to the apparatus for retreatment.

Incoming water from the ballast water inlet may be used to backflush the filter.

The settling tank may include an inlet and an outlet. The settling tank may include one or more filter screens, the one or more filter screens being located between the inlet and outlet. The settling tank may include two filter screens. Each filter screen may have different filtering properties. Each screen may have different filter aperture sizes.

The backflush pump may be a centrifugal pump. The backflush pump may be rated at similar capacity to the maximum permitted backflush flow rate of the filter.

The backflush strainers may be inline basket strainers. The backflush strainers may include a 40 micron filter element. The filter may include a filter element between 30 micron and 40 micron.

The backflush handling system may include a plurality of backflush strainers. The backflush handling system may include four backflush strainers.

The backflush strainers may be arranged to be selectively, or independently, operable.

The apparatus may further comprise a water monitoring unit, the water monitoring unit being operable to monitor at least one parameter of the water passing through the apparatus.

The water monitoring unit may be operable to compare the at least one monitored parameter with at least one predetermined parameter, or at least one reference parameter. The water monitoring unit may be operable to compare the at least one monitored parameter, or parameters, with at least one predetermined parameter, or parameters. The water monitoring unit may be operable to compare the at least one monitored parameter, or parameters, with at least one reference parameter, or parameters.

The operation of backflush handling system may be dependent upon the monitored at least one parameter. The operation of backflush handling system may be dependent upon the comparison of the at least one monitored parameter and the at least one reference parameter. The operation of backflush handling system may be dependent upon the monitored at least one parameter of incoming ballast water.

The operation of the backflush handling system may be dependent upon a sensor-derived measurement of at least one parameter of the incoming ballast water. The measurement of the at least one parameter of the incoming ballast water may be obtained by an in-line sensor, which may be a dissolved organic matter sensor, a turbidity sensor, a UV transmittance sensor, or a water sedimentation sensor. The at least one parameter may be a measurement of the quality of the water. The quality of the water measurement may be determined by the amount of aquatic organisms (of a certain size and/or type) contained therein.

The operation of the backflush handling system may be automated. The operation of the backflush handling system may be an automated operation based on the sensor-derived measurement of the at least one parameter of the incoming ballast water.

The backflush handling system may be configured to be selectively operable to pass backflush liquid:
(i) directly to the backflush return outlet, or
(ii) to the backflush treatment apparatus, with clarified liquid from the backflush treatment apparatus then being passed to the backflush return outlet, or
(iii) to the backflush treatment apparatus, with clarified liquid from the backflush treatment apparatus then being recycled to a point upstream of the filter.

The apparatus may include one or more filter bypass circuits. The filter bypass circuits being configured to allow incoming water to bypass the filter. The filter may be selectively bypassed to permit water treatment only of previously filtered water.

The apparatus may be housed within a container. The container may be an ISO 20 foot container. The container may be an ISO 20 foot High Cube container.

In certain embodiments, the filter can be selectively bypassed to permit water treatment only of previously filtered water.

The apparatus may further comprise a water monitoring unit, the water monitoring unit being operable to monitor at least one parameter of the water passing through the apparatus.

The water monitoring unit may be operable to sample the treated water. The water monitoring unit may be operable to sample the treated water and compare the at least one monitored parameter with at least one reference parameter. The at least one reference parameter may be a pre-determined discharge acceptable standard according to the International Maritime Organisation (IMO) and/or US Coast Guard (USCG).

The water monitoring unit may be operable to provide an indication of the comparison between the at least one monitored parameter with at least one reference parameter. The indication may be a visual indication. The indication may be a visible “pass” or “fail”, depending on how the at least one monitored parameter with at least one reference parameter.

The water monitoring unit may be operable to compare the at least one monitored parameter with at least one reference parameter in real time.

The water monitoring unit may also include one or more data logging devices operable to store data relating to the monitored parameters and the comparison between the at least one reference parameter. The indication of comparison being between the at least one monitored parameter with at least one reference parameter.

The water monitoring unit may be operable to prevent discharge of ballast water if the at least one monitored parameter of the ballast water does not meet pre-determined standards, or certain compliance conditions.

The apparatus may be configured such that ballast water that does not meet pre-determined standards, or certain compliance conditions, is recirculated for retreatment. The ballast water may be recirculated in the apparatus until the ballast water meets pre-determined standards, or certain compliance conditions. In this arrangement the apparatus may include one or more flow paths, or pipework, that redirects ballast water that does not meet pre-determined standards, or certain compliance conditions, back to the ballast tank for retreatment. The apparatus may include a ballast tank return outlet. The ballast tank return outlet being configured to return ballast water that does not meet pre-determined standards, or certain compliance conditions, back to the ballast tank for retreatment.

The apparatus may include two or more ballast water inlets. The apparatus may include a first ballast water inlet and a second ballast water inlet.

The two or more ballast water inlets may join together downstream of the inlets. The two or more ballast water inlets may join downstream of the inlets to become a single flow path.

Each ballast water inlet may be associated with, or include, a control valve. The control valve may be operable to control the flow rate of water therethrough.

Each ballast water inlet may be associated with, or include, a flow meter. The flow meter may be operable to measure, or determine, the flow rate of water through the inlet and/or control valve. Each flow meter may be located downstream, or upstream, of the control valve. Each flow meter may be operable to control the operation of the control valve. Each flow meter may be operable to control the operation of the control valve such that the flow rates of water passing through each inlet and/or control valve is substantially equal. Each flow meter may be operable to automatically control the operation of the control valve. Each flow meter may be operable to automatically control the operation of the control valve such that the flow rates of water passing through each inlet and/or control valve are substantially equal.

The apparatus may include two or more treated ballast water outlets. The apparatus may include a first treated ballast water outlet and a second treated ballast water outlet.

The two or more treated ballast water outlets may join together upstream of the outlets. The two or more treated ballast water outlets may join upstream of the outlets from a single flow path.

Each treated ballast water outlet may be associated with, or include, a control valve. The control valve may be operable to control the flow rate of water therethrough.

Each treated ballast water outlet may be associated with, or include, a flow meter. The flow meter may be operable to measure, or determine, the flow rate of water through the outlet and/or control valve. Each flow meter may be located downstream, or upstream, of the control valve. Each flow meter may be operable to control the operation of the control valve. Each flow meter may be operable to control the operation of the control valve such that the flow rates of water passing through each outlet and/or control valve is substantially equal. Each flow meter may be operable to automatically control the operation of the control valve. Each flow meter may be operable to automatically control the operation of the control valve such that the flow rates of water passing through each outlet and/or control valve are substantially equal.

The apparatus may include two or more ballast tank return outlets. The apparatus may include a first ballast tank return outlet and a second ballast tank return outlet.

The two or more ballast tank return outlets are associated with the treated ballast water outlets.

Each ballast tank return outlet may be associated with, or include, a control valve. The control valve may be operable to control the flow rate of water therethrough.

Each ballast tank return outlet may be associated with the flow meter of the treated ballast water outlet. The flow meter may be operable to control the operation of the control valves of the treated ballast water outlet and ballast tank return outlet to select where treated water should be dispatched. The flow meter may be operable to measure, or determine, the flow rate of water through the outlet and/or control valve. Each flow meter may be located downstream, or upstream, of the control valve. Each flow meter may be operable to control the operation of the control valve. Each flow meter may be operable to control the operation of the control valve such that the flow rates of water passing through each outlet and/or control valve is substantially equal. Each flow meter may be operable to automatically control the operation of the control valve. Each flow meter may be operable to automatically control the operation of the control valve such that the flow rates of water passing through each outlet and/or control valve are substantially equal.

The apparatus may further comprise one or more valves which are selectively operable to pass a proportion of incoming water and/or treated water through the water monitoring unit.

The apparatus may further comprise an auxiliary pumping system. The auxiliary pumping system may include a pump (stripping pump) and one or more strainers. Each strainer may be associated with a control valve. The pump may be a diaphragm pump, a low profile “puddle pump” or potentially a submersible pump, or the like.

The apparatus may further comprise an auxiliary pump inlet. The auxiliary pump inlet being configured to be connectable to the auxiliary pumping system. The auxiliary pump inlet may be configured to be connectable to a ballast tank.

The auxiliary pumping system may be configured and operable to remove residual ballast water that cannot otherwise be removed from a ballast tank by pumps normally associated with ships, barges etc.

The apparatus may further comprise a control system. The control system may be operable to control the operation of one or more, or all, of: the water treatment unit; the water monitoring unit; all valves and control valves of the apparatus; the control valves of the ballast water inlets, treated ballast water outlets and ballast return outlets; the flow meters of the ballast water inlets and treated ballast water outlets; the backflush handling system; the auxiliary pumping system and the incoming water analysis unit.

The control system may be located with the apparatus.

The control system may be located remotely from the apparatus. The control system may be configured to operate the apparatus from a remote location. The control system may include a hand-held operating device. The hand-held operating device being configured to control the operation of the apparatus. The hand-held operating device, or control system, may be hard-wired to the apparatus for the operation thereof. The hand-held operating device, or control system, may be configured to operate the apparatus wirelessly. The wireless operation may be of any suitable wireless protocol communication system, including 3G, 4G etc.

Both of the foregoing aspects of the invention may be combined to provide an apparatus for treating ballast water comprising:
a ballast water inlet;
a treated ballast water outlet;
a filter;
a water treatment unit, wherein the filter and the water treatment unit are arranged sequentially between the ballast water inlet and the ballast water outlet;
a water monitoring unit, the water monitoring unit being operable to monitor at least one parameter of the water passing through the apparatus; and
a backflush handling system connected to receive backflush liquid from the filter.

The above apparatus may be considered a third aspect of the present invention.

Embodiments of second aspect of the present invention may include one or more features of the first aspect of the present invention or its embodiments. Similarly, embodiments of the first aspect of the present invention may include one or more features of the second aspect of the present invention or its embodiments. Also, embodiments of the third aspect of the present invention may include one or more features of the first and/or second aspect of the present invention or its embodiments.

According to a fourth aspect of the present invention there is provided a method of treating ballast water comprising the steps of:
providing an apparatus for treating ballast water comprising:
   a ballast water inlet;
   a treated ballast water outlet;
   a filter;
   a water treatment unit, wherein the filter and the water treatment unit are arranged sequentially between the ballast water inlet and the ballast water outlet; and
   a water monitoring unit, the water monitoring unit being operable to monitor at least one parameter of the water
passing through the apparatus,
passing water into the ballast water inlet;
filtering the water through the filter;
treating the filtered water with the water treatment unit; and
monitoring the treated water with the water monitoring unit.

The water treatment unit may be operable to kill or render moribund aquatic organisms or species in the ballast water. The water treatment unit may be operable to kill or render moribund aquatic organisms or species in the ballast water in accordance with legislative standards. The legislative standards may be the International Convention for Control and Management of Ships' Ballast Water and Sediments. The legislative standard may be the D-2 requirement established by the International Maritime Organisation (IMO).

The water treatment unit may be an ultraviolet (UV) treatment unit. The water treatment unit may be an electro chlorination treatment unit. The water treatment unit may be an ozone treatment unit. The water treatment unit may be a chemical treatment unit. The water treatment unit may be an ultrasonic treatment unit. The water treatment unit may be a deoxygenation treatment unit. The water treatment unit may include one or more of the water treatment units described above. The water treatment unit may comprise a combination of any two or more of an ultraviolet (UV) treatment unit, an electro chlorination treatment unit, an ozone treatment unit, a chemical treatment unit, an ultrasonic treatment unit and a deoxygenation treatment unit. All of the above water treatment units are operable to kill or render moribund aquatic organisms or species in the ballast water.

The incoming water may be monitored with the water monitoring unit.

The water may be continuously monitored with the water monitoring unit.

The ballast water inlet may be configured to be connectable to a source of ballast water. The source of ballast water may be sea water.

The treated ballast water outlet may be configured to be connectable to a ship's ballast tank, or tanks.

The method may comprise the further step of passing treated water to the ship's ballast tank, or tanks.

The filter may be a screen filter. The filter may include a 40 micron filter element. The filter may include a filter element between 30 micron and 40 micron.

The filter may be configured to be operable across an approximate pressure drop of 0.1 to 0.4 bar.

The filter and the water treatment unit may be arranged in series. The filter and the water treatment unit may be arranged such that the water treatment unit is closer to the treated ballast water outlet than the filter. Alternatively, the filter and the water treatment unit may be arranged such that the filter unit is closer to the treated ballast water outlet than the water treatment unit.

The water monitoring unit may be configured and operable to monitor two or more parameters of water passing through the apparatus. The water monitoring unit may be configured and operable to monitor a plurality of parameters of water passing through the apparatus.

The method may comprise the further step of monitoring one or more parameters of water passing through the apparatus.

The water monitoring unit may be operable to monitor the quality of the water passing through the apparatus. The water monitoring unit may be operable to monitor the contents of the water passing through the apparatus. The water monitoring unit may be operable to monitor the aquatic organism contents of the water passing through the apparatus.

The method may comprise the further step of monitoring the quality of the water passing through the apparatus. The method may comprise the further step of monitoring the contents of the water passing through the apparatus. The method may comprise the further step of monitoring the aquatic organisms passing through the apparatus.

The water monitoring unit may be operable to monitor particle size. The water monitoring unit may be operable to detect the presence of particles. The water monitoring unit may be operable to detect the presence of particles of micro-organisms. The water monitoring unit may be operable to detect the amount of an aquatic organism, or aquatic organisms, present in a particular volume of water.

The method may comprise the further step of detecting particles in the water passing through the apparatus. The method may comprise the further step of detecting the presence of particles in the water passing through the apparatus. The method may comprise the further step of detecting the amount of an aquatic organism, or aquatic organisms, present in a particular volume of water passing through the apparatus.

The water monitoring unit may also include one or more data logging devices operable to store data relating to the monitored parameters.

The method may comprise the further step of logging data relating to the monitored parameters.

The water monitoring unit may be operable to compare the at least one monitored parameter with at least one predetermined parameter, or at least one reference parameter. The water monitoring unit may be operable to compare the at least one monitored parameter, or parameters, with at least one predetermined parameter, or parameters. The water monitoring unit may be operable to compare the at least one monitored parameter, or parameters, with at least one reference parameter, or parameters.

The method may comprise the further step of comparing the at least one monitored parameter, or parameters, with at least one predetermined parameter, or parameters, or at least one reference parameter, or parameters.

The water monitoring unit may be operable to monitor the quality of incoming water. The water monitoring unit may be operable to monitor the quality of treated water. The water monitoring unit may be operable to monitor the quality of both incoming water and treated water.

The method may comprise the further step of monitoring the quality of incoming water. The method may comprise the further step of monitoring the quality of treated water. The method may comprise the further step of monitoring the quality of both incoming and treated water.

The water monitoring unit may be operable to sample the treated water. The water monitoring unit may be operable to sample the treated water and compare the at least one monitored parameter with at least one reference parameter. The at least one reference parameter may be a pre-determined discharge acceptable standard according to the International Maritime Organisation (IMO) and/or US Coast Guard (USCG).

The water monitoring unit may be operable to provide an indication of the comparison between the at least one monitored parameter with at least one reference parameter. The indication may be a visual indication. The indication may be a visible “pass” or “fail”, depending on how the at least one monitored parameter with at least one reference parameter.

The water monitoring unit may be operable to compare the at least one monitored parameter with at least one reference parameter in real time.

The water monitoring unit may also include one or more data logging devices operable to store data relating to the monitored parameters and the comparison between the at least one reference parameter. The indication of comparison being between the at least one monitored parameter with at least one reference parameter.

The water may be monitored continuously with the water monitoring unit.

The water monitoring unit may be based on a single turnover fluorescence (STF) induction method of detection.

The apparatus may further comprise one or more valves which are selectively operable to pass a proportion of incoming water and/or treated water through the water monitoring unit.

The method may include the further step of selectively passing incoming water and/or treated water through the monitoring unit.

The apparatus may further comprise a backflush return outlet.

The apparatus may include one or more filter bypass circuits. The filter bypass circuits being configured to allow incoming water to bypass the filter. The filter may be selectively bypassed to permit water treatment only of previously filtered water.

The method may include the further step of selectively bypassing the incoming water around the filter.

The method may comprise the step of treating ballast water during discharge. The water being discharged having previously been subjected to filtration and water treatment. The method may comprise the further step of subjecting the discharge water to water treatment. The method may comprise the further step of monitoring at least one parameter of the treated discharge water with the water monitoring apparatus.

In the above-described arrangements at least one parameter of the water is monitored before and after treatment.

The monitoring of the water may be monitored in “real time”.

The water monitoring unit may be operable to prevent discharge of ballast water if the at least one monitored parameter of the ballast water does not meet pre-determined standards, or certain compliance conditions.

The apparatus may be configured such that ballast water that does not meet pre-determined standards, or certain compliance conditions, is recirculated for retreatment. The ballast water may be recirculated in the apparatus until the ballast water meets pre-determined standards, or certain compliance conditions. In this arrangement the apparatus may include one or more flow paths, or pipework, that redirects ballast water that does not meet pre-determined standards, or certain compliance conditions, back to the ballast tank for retreatment. The apparatus may include a ballast tank return outlet. The ballast tank return outlet being configured to return ballast water that does not meet pre-determined standards, or certain compliance conditions, back to the ballast tank for retreatment.

The apparatus may include two or more ballast water inlets. The apparatus may include a first ballast water inlet and a second ballast water inlet.

The two or more ballast water inlets may join together downstream of the inlets. The two or more ballast water inlets may join downstream of the inlets to become a single flow path.

Each ballast water inlet may be associated with, or include, a control valve. The control valve may be operable to control the flow rate of water therethrough. The method may comprise the step of operating the control valve of each ballast water inlet. The method may comprise the step of operating the control valve of each ballast water inlet such that the flow rates of water passing through each inlet and/or control valve is substantially equal. The method may comprise the step of automatically operating the control valve of each ballast water inlet such that the flow rates of water passing through each inlet and/or control valve is substantially equal.

Each ballast water inlet may be associated with, or include, a flow meter. The flow meter may be operable to measure, or determine, the flow rate of water through the inlet and/or control valve. Each flow meter may be located downstream, or upstream, of the control valve. Each flow meter may be operable to control the operation of the control valve. Each flow meter may be operable to control the operation of the control valve such that the flow rates of water passing through each inlet and/or control valve is substantially equal. Each flow meter may be operable to automatically control the operation of the control valve. Each flow meter may be operable to automatically control the operation of the control valve such that the flow rates of water passing through each inlet and/or control valve are substantially equal. The method may comprise the step of operating the flow meter of each ballast water inlet such that the flow rates of water passing through each inlet and/or control valve is substantially equal. The method may comprise the step of automatically operating the flow meter of each ballast water inlet such that the flow rates of water passing through each inlet and/or control valve is substantially equal.

The apparatus may include two or more treated ballast water outlets. The apparatus may include a first treated ballast water outlet and a second treated ballast water outlet.

The two or more treated ballast water outlets may join together upstream of the outlets. The two or more treated ballast water outlets may join upstream of the outlets from a single flow path.

Each treated ballast water outlet may be associated with, or include, a control valve. The control valve may be operable to control the flow rate of water therethrough. The method may comprise the step of operating the control valve of each treated ballast water outlet. The method may comprise the step of operating the control valve of each treated ballast water outlet such that the flow rates of water passing through each outlet and/or control valve is substantially equal. The method may comprise the step of automatically operating the control valve of each treated ballast water outlet such that the flow rates of water passing through each outlet and/or control valve is substantially equal.

Each treated ballast water outlet may be associated with, or include, a flow meter. The flow meter may be operable to measure, or determine, the flow rate of water through the outlet and/or control valve. Each flow meter may be located downstream, or upstream, of the control valve. Each flow meter may be operable to control the operation of the control valve. Each flow meter may be operable to control the operation of the control valve such that the flow rates of water passing through each outlet and/or control valve is substantially equal. Each flow meter may be operable to automatically control the operation of the control valve. Each flow meter may be operable to automatically control the operation of the control valve such that the flow rates of water passing through each outlet and/or control valve are substantially equal. The method may comprise the step of operating the flow meter of each treated ballast water outlet such that the flow rates of water passing through each outlet and/or control valve is substantially equal. The method may comprise the step of automatically operating the flow meter of each treated ballast water outlet such that the flow rates of water passing through each outlet and/or control valve is substantially equal.

The apparatus may include two or more ballast tank return outlets. The apparatus may include a first ballast tank return outlet and a second ballast tank return outlet.

The two or more ballast tank return outlets are associated with the treated ballast water outlets.

Each ballast tank return outlet may be associated with, or include, a control valve. The control valve may be operable to control the flow rate of water therethrough. The method may comprise the step of operating the control valve of each ballast tank return outlet. The method may comprise the step of operating the control valve of each ballast tank return outlet such that the flow rates of water passing through each outlet and/or control valve is substantially equal. The method may comprise the step of automatically operating the control valve of each ballast tank return outlet such that the flow rates of water passing through each outlet and/or control valve is substantially equal.

Each ballast tank return outlet may be associated with the flow meter of the treated ballast water outlet. The flow meter may be operable to control the operation of the control valves of the treated ballast water outlet and ballast tank return outlet to select where treated water should be dispatched. The flow meter may be operable to measure, or determine, the flow rate of water through the outlet and/or control valve. Each flow meter may be located downstream, or upstream, of the control valve. Each flow meter may be operable to control the operation of the control valve. Each flow meter may be operable to control the operation of the control valve such that the flow rates of water passing through each outlet and/or control valve is substantially equal. Each flow meter may be operable to automatically control the operation of the control valve. Each flow meter may be operable to automatically control the operation of the control valve such that the flow rates of water passing through each outlet and/or control valve are substantially equal. The method may comprise the further step of controlling the operation of the control valves of the treated ballast water outlet and ballast tank return outlet to select where treated water should be dispatched. The method may comprise the step of operating the flow meter of each treated ballast water outlet such that the flow rates of water passing through each outlet and/or control valve is substantially equal. The method may comprise the step of automatically operating the flow meter of each treated ballast water outlet such that the flow rates of water passing through each outlet and/or control valve are substantially equal.

The apparatus may further comprise a backflush handling system connected to receive backflush liquid from the filter.

The apparatus may further comprise an auxiliary pumping system. The auxiliary pumping system may include a pump (stripping pump) and one or more strainers. Each strainer may be associated with a control valve. The pump may be a diaphragm pump, a low profile “puddle pump” or potentially a submersible pump, or the like.

The apparatus may further comprise an auxiliary pump inlet. The auxiliary pump inlet being configured to be connectable to the auxiliary pumping system. The auxiliary pump inlet may be configured to be connectable to a ballast tank.

The auxiliary pumping system may be configured and operable to remove residual ballast water that cannot otherwise be removed from a ballast tank by pumps normally associated with ships, barges etc. The method may comprise the further step of using the auxiliary pumping system to remove residual ballast water from a tank. The method may include the step of removing and filtering, or straining, the residual ballast water. The step of removing residual ballast water from a tank with the auxiliary pumping system may be an initial step before treated ballast water is loaded to the tank.

The apparatus may further comprise a control system. The control system may be operable to control the operation of one or more, or all, of: the water treatment unit; the water monitoring unit; all valves and control valves of the apparatus; the control valves of the ballast water inlets, treated ballast water outlets and ballast return outlets; the flow meters of the ballast water inlets and treated ballast water outlets; the backflush handling system; the auxiliary pumping system and the incoming water analysis unit.

The method may include the further step of using the control system to control the operation of one or more, or all, of: the water treatment unit; the water monitoring unit; all valves and control valves of the apparatus; the control valves of the ballast water inlets, treated ballast water outlets and ballast return outlets; the flow meters of the ballast water inlets and treated ballast water outlets; the backflush handling system; the auxiliary pumping system and the incoming water analysis unit.

The control system may be located with the apparatus.

The control system may be located remotely from the apparatus. The control system may be configured to operate the apparatus from a remote location. The control system may include a hand-held operating device. The hand-held operating device being configured to control the operation of the apparatus. The hand-held operating device, or control system, may be hard-wired to the apparatus for the operation thereof. The hand-held operating device, or control system, may be configured to operate the apparatus wirelessly. The wireless operation may be of any suitable wireless protocol communication system, including 3G, 4G etc.

According to a fifth aspect of the present invention there is provided a method of treating ballast water comprising the steps of:
providing an apparatus for treating ballast water comprising:
   a ballast water inlet;
   a treated ballast water outlet;
   a filter;
   a water treatment unit, wherein the filter and the water treatment unit are arranged sequentially between the ballast water inlet and the ballast water outlet; and
   a backflush handling system connected to receive backflush liquid from the filter, the backflush handling system comprising a backflush treatment apparatus backflushing liquid through the filter;
passing the backflush liquid to a backflush return outlet;
or
passing the backflush liquid to the backflush treatment apparatus and passing clarified backflush liquid from the backflush treatment apparatus to the backflush return outlet;
or
passing the backflush liquid to the backflush treatment apparatus, then passing clarified backflush liquid from the backflush treatment apparatus to a point upstream of the filter; and
filtering the water through the filter; and
treating the filtered water with the water treatment unit.

The water treatment unit may be operable to kill or render moribund aquatic organisms or species in the ballast water. The water treatment unit may be operable to kill or render moribund aquatic organisms or species in the ballast water in accordance with legislative standards. The legislative standards may be the International Convention for Control and Management of Ships' Ballast Water and Sediments. The legislative standard may be the D-2 requirement established by the International Maritime Organisation (IMO).

The water treatment unit may be an ultraviolet (UV) treatment unit. The water treatment unit may be an electro chlorination treatment unit. The water treatment unit may be an ozone treatment unit. The water treatment unit may be a chemical treatment unit. The water treatment unit may be an ultrasonic treatment unit. The water treatment unit may be a deoxygenation treatment unit. The water treatment unit may include one or more of the water treatment units described above. The water treatment unit may comprise a combination of any two or more of an ultraviolet (UV) treatment unit, an electro chlorination treatment unit, an ozone treatment unit, a chemical treatment unit, an ultrasonic treatment unit and a deoxygenation treatment unit. All of the above water treatment units are operable to kill or render moribund aquatic organisms or species in the ballast water.

The point upstream of the filter may be termed a recycling point.

The method may use incoming water from the ballast water inlet to backflush the filter.

The backflush treatment apparatus may comprise a settling tank, a backflush pump and one or more backflush strainers. The settling tank, backflush pump and backflush strainers being operable to separate sediment from the water.

The backflush treatment apparatus may additionally or alternatively comprise at least one centrifugal separator, at least one cyclonic separator or at least one clarifier. The at least one centrifugal separator, at least one cyclonic separator and the at least one clarifier being operable to separate sediment from the water.

The backflush treatment apparatus may be operable to separate sediment from the water and drain the sediment to a sediment storage vessel. The backflush treatment apparatus may be operable to reintroduce the sediment-free water back to the apparatus for retreatment.

The settling tank may include an inlet and an outlet. The settling tank may include one or more filter screens, the one or more filter screens being located between the inlet and outlet. The settling tank may include two filter screens. Each filter screen may have different filtering properties. Each screen may have different filter aperture sizes.

The backflush pump may be a centrifugal pump. The backflush pump may be rated at similar capacity to the maximum permitted backflush flow rate of the filter.

The backflush strainers may be inline basket strainers. The backflush strainers may include a 40 micron filter element. The filter may include a filter element between 30 micron and 40 micron.

The backflush handling system may include a plurality of backflush strainers. The backflush handling system may include four backflush strainers.

The backflush strainers may be arranged to be selectively, or independently, operable.

The method may comprise the further step of selectively operating the backflush strainers.

The operation of backflush handling system may be dependent upon the monitored at least one parameter. The operation of backflush handling system may be dependent upon the comparison of the at least one monitored parameter and the at least one reference parameter. The operation of backflush handling system may be dependent upon the monitored at least one parameter of incoming ballast water.

The operation of the backflush handling system may be dependent upon a sensor-derived measurement of at least one parameter of the incoming ballast water. The measurement of the at least one parameter of the incoming ballast water may be obtained by an in-line sensor, which may be a dissolved organic matter sensor, a turbidity sensor, a UV transmittance sensor, or a water sedimentation sensor. The at least one parameter may be a measurement of the quality of the water. The quality of the water measurement may be determined by the amount of aquatic organisms (of a certain size and/or type) contained therein.

The operation of the backflush handling system may be automated. The operation of the backflush handling system may be an automated operation based on the sensor-derived measurement of the at least one parameter of the incoming ballast water.

The backflush handling system may be configured to be selectively operable to pass backflush liquid:
(i) directly to the backflush return outlet, or
(ii) to the backflush treatment apparatus, with clarified liquid from the backflush treatment apparatus then being passed to the backflush return outlet, or
(iii) to the backflush treatment apparatus, with clarified liquid from the backflush treatment apparatus then being recycled to a point upstream of the filter.

The method may comprise the further step of operating the backflush handling system to backflush liquid:
(i) directly to the backflush return outlet, or
(ii) to the backflush treatment apparatus, with clarified liquid from the backflush treatment apparatus then being passed to the backflush return outlet, or
(iii) to the backflush treatment apparatus, with clarified liquid from the backflush treatment apparatus then being recycled to a point upstream of the filter.

The method may comprise the further step of selectively operating the backflush handling system in dependence on the sensor-derived measurement of at least one parameter of the incoming ballast water.

The apparatus may include one or more filter bypass circuits. The filter bypass circuits being configured to allow incoming water to bypass the filter. The filter may be selectively bypassed to permit water treatment only of previously filtered water.

The method may include the further step of selectively bypassing the filter and passing treated water through the water treatment unit.

The apparatus may be housed within a container. The container may be an ISO 20 foot container.

The apparatus may further comprise a water monitoring unit, the water monitoring unit being operable to monitor at least one parameter of the water passing through the apparatus.

The water monitoring unit may be operable to sample the treated water. The water monitoring unit may be operable to sample the treated water and compare the at least one monitored parameter with at least one reference parameter. The at least one reference parameter may be a pre-determined discharge acceptable standard according to the International Maritime Organisation (IMO) and/or US Coast Guard (USCG).

The water monitoring unit may be operable to provide an indication of the comparison between the at least one monitored parameter with at least one reference parameter. The indication may be a visual indication. The indication may be a visible “pass” or “fail”, depending on how the at least one monitored parameter with at least one reference parameter.

The water monitoring unit may be operable to compare the at least one monitored parameter with at least one reference parameter in real time.

The water monitoring unit may also include one or more data logging devices operable to store data relating to the monitored parameters and the comparison between the at least one reference parameter. The indication of comparison being between the at least one monitored parameter with at least one reference parameter.

The apparatus may be configured such that ballast water that does not meet pre-determined standards, or certain compliance conditions, is recirculated for retreatment. The ballast water may be recirculated in the apparatus until the ballast water meets pre-determined standards, or certain compliance conditions. In this arrangement the apparatus may include one or more flow paths, or pipework, that redirects ballast water that does not meet pre-determined standards, or certain compliance conditions, back to the ballast tank for retreatment. The apparatus may include a ballast tank return outlet. The ballast tank return outlet being configured to return ballast water that does not meet pre-determined standards, or certain compliance conditions, back to the ballast tank for retreatment.

The apparatus may include two or more ballast water inlets. The apparatus may include a first ballast water inlet and a second ballast water inlet.

The two or more ballast water inlets may join together downstream of the inlets. The two or more ballast water inlets may join downstream of the inlets to become a single flow path.

Each ballast water inlet may be associated with, or include, a control valve. The control valve may be operable to control the flow rate of water therethrough. The method may comprise the step of operating the control valve of each ballast water inlet. The method may comprise the step of operating the control valve of each ballast water inlet such that the flow rates of water passing through each inlet and/or control valve is substantially equal. The method may comprise the step of automatically operating the control valve of each ballast water inlet such that the flow rates of water passing through each inlet and/or control valve is substantially equal.

Each ballast water inlet may be associated with, or include, a flow meter. The flow meter may be operable to measure, or determine, the flow rate of water through the inlet and/or control valve. Each flow meter may be located downstream, or upstream, of the control valve. Each flow meter may be operable to control the operation of the control valve. Each flow meter may be operable to control the operation of the control valve such that the flow rates of water passing through each inlet and/or control valve is substantially equal. Each flow meter may be operable to automatically control the operation of the control valve. Each flow meter may be operable to automatically control the operation of the control valve such that the flow rates of water passing through each inlet and/or control valve are substantially equal. The method may comprise the step of operating the flow meter of each ballast water inlet such that the flow rates of water passing through each inlet and/or control valve is substantially equal. The method may comprise the step of automatically operating the flow meter of each ballast water inlet such that the flow rates of water passing through each inlet and/or control valve is substantially equal.

The apparatus may include two or more treated ballast water outlets. The apparatus may include a first treated ballast water outlet and a second treated ballast water outlet.

The two or more treated ballast water outlets may join together upstream of the outlets. The two or more treated ballast water outlets may join upstream of the outlets from a single flow path.

Each treated ballast water outlet may be associated with, or include, a control valve. The control valve may be operable to control the flow rate of water therethrough. The method may comprise the step of operating the control valve of each treated ballast water outlet. The method may comprise the step of operating the control valve of each treated ballast water outlet such that the flow rates of water passing through each outlet and/or control valve is substantially equal. The method may comprise the step of automatically operating the control valve of each treated ballast water outlet such that the flow rates of water passing through each outlet and/or control valve is substantially equal.

Each treated ballast water outlet may be associated with, or include, a flow meter. The flow meter may be operable to measure, or determine, the flow rate of water through the outlet and/or control valve. Each flow meter may be located downstream, or upstream, of the control valve. Each flow meter may be operable to control the operation of the control valve. Each flow meter may be operable to control the operation of the control valve such that the flow rates of water passing through each outlet and/or control valve is substantially equal. Each flow meter may be operable to automatically control the operation of the control valve. Each flow meter may be operable to automatically control the operation of the control valve such that the flow rates of water passing through each outlet and/or control valve are substantially equal. The method may comprise the step of operating the flow meter of each treated ballast water outlet such that the flow rates of water passing through each outlet and/or control valve is substantially equal. The method may comprise the step of automatically operating the flow meter of each treated ballast water outlet such that the flow rates of water passing through each outlet and/or control valve is substantially equal.

The apparatus may include two or more ballast tank return outlets. The apparatus may include a first ballast tank return outlet and a second ballast tank return outlet.

The two or more ballast tank return outlets are associated with the treated ballast water outlets.

Each ballast tank return outlet may be associated with, or include, a control valve. The control valve may be operable to control the flow rate of water therethrough. The method may comprise the step of operating the control valve of each ballast tank return outlet. The method may comprise the step of operating the control valve of each ballast tank return outlet such that the flow rates of water passing through each outlet and/or control valve is substantially equal. The method may comprise the step of automatically operating the control valve of each ballast tank return outlet such that the flow rates of water passing through each outlet and/or control valve is substantially equal.

Each ballast tank return outlet may be associated with the flow meter of the treated ballast water outlet. The flow meter may be operable to control the operation of the control valves of the treated ballast water outlet and ballast tank return outlet to select where treated water should be dispatched. The flow meter may be operable to measure, or determine, the flow rate of water through the outlet and/or control valve. Each flow meter may be located downstream, or upstream, of the control valve. Each flow meter may be operable to control the operation of the control valve. Each flow meter may be operable to control the operation of the control valve such that the flow rates of water passing through each outlet and/or control valve is substantially equal. Each flow meter may be operable to automatically control the operation of the control valve. Each flow meter may be operable to automatically control the operation of the control valve such that the flow rates of water passing through each outlet and/or control valve are substantially equal. The method may comprise the further step of controlling the operation of the control valves of the treated ballast water outlet and ballast tank return outlet to select where treated water should be dispatched. The method may comprise the step of operating the flow meter of each treated ballast water outlet such that the flow rates of water passing through each outlet and/or control valve is substantially equal. The method may comprise the step of automatically operating the flow meter of each treated ballast water outlet such that the flow rates of water passing through each outlet and/or control valve is substantially equal.

The apparatus may further comprise an auxiliary pumping system. The auxiliary pumping system may include a pump (stripping pump) and one or more strainers. Each strainer may be associated with a control valve. The pump may be a diaphragm pump, a low profile “puddle pump” or potentially a submersible pump, or the like.

The apparatus may further comprise an auxiliary pump inlet. The auxiliary pump inlet being configured to be connectable to the auxiliary pumping system. The auxiliary pump inlet may be configured to be connectable to a ballast tank.

The auxiliary pumping system may be configured and operable to remove residual ballast water that cannot otherwise be removed from a ballast tank by pumps normally associated with ships, barges etc. The method may comprise the further step of using the auxiliary pumping system to remove residual ballast water from a tank. The method may include the step of removing and filtering, or straining, the residual ballast water. The step of removing residual ballast water from a tank with the auxiliary pumping system may be an initial step before treated ballast water is loaded to the tank.

The apparatus may further comprise a control system. The control system may be operable to control the operation of one or more, or all, of: the water treatment unit; the water monitoring unit; all valves and control valves of the apparatus; the control valves of the ballast water inlets, treated ballast water outlets and ballast return outlets; the flow meters of the ballast water inlets and treated ballast water outlets; the backflush handling system; the auxiliary pumping system and the incoming water analysis unit.

The method may include the further step of using the control system to control the operation of one or more, or all, of: the water treatment unit; the water monitoring unit; all valves and control valves of the apparatus; the control valves of the ballast water inlets, treated ballast water outlets and ballast return outlets; the flow meters of the ballast water inlets and treated ballast water outlets; the backflush handling system; the auxiliary pumping system and the incoming water analysis unit.

The control system may be located with the apparatus.

The control system may be located remotely from the apparatus. The control system may be configured to operate the apparatus from a remote location. The control system may include a hand-held operating device. The hand-held operating device being configured to control the operation of the apparatus. The hand-held operating device, or control system, may be hard-wired to the apparatus for the operation thereof. The hand-held operating device, or control system, may be configured to operate the apparatus wirelessly. The wireless operation may be of any suitable wireless protocol communication system, including 3G, 4G etc.

Embodiments of fifth aspect of the present invention may include one or more features of the fourth aspect of the present invention or its embodiments. Similarly, embodiments of the fourth aspect of the present invention may include one or more features of the fifth aspect of the present invention or its embodiments.

According to a sixth aspect of the present invention there is provided an apparatus for treating ballast water, comprising an inlet and an outlet, and a filter and a water treatment unit arranged sequentially between the inlet and the outlet; and further comprising a monitoring unit arranged to monitor the quality of water passing through the apparatus.

Embodiments of sixth aspect of the present invention may include one or more features of the first or second aspects of the present invention or its embodiments.

According to a seventh aspect of the present invention there is provided an apparatus for treating ballast water, comprising an inlet and an outlet, and a filter and a water treatment unit arranged sequentially between the inlet and the outlet; and further comprising a backflush handling system connected to receive backflush liquid from the filter.

Embodiments of seventh aspect of the present invention may include one or more features of the first, second, third or sixth aspects of the present invention or its embodiments. Similarly, embodiments of the sixth aspect of the present invention may include one or more features of the seventh aspect of the present invention or its embodiments.

According to an eighth aspect of the present invention there is provided a method of treating ballast water, comprising subjecting the ballast water to filtration followed by water treatment, and monitoring the water quality.

The water quality may be continuously monitored.

According to a ninth aspect of the present invention there is provided a method of treating ballast water during discharge, the water being discharged having previously been subjected to filtration and water treatment, the method comprising subjecting the discharge water to water treatment, and continuously monitoring the water quality.

The water quality is preferably monitored both before and after treatment in the eighth and ninth aspect of the invention.

The water quality data may be logged for future review or analysis.

Real time water quality data may be used to enable treated water of unacceptable quality to be returned to source.

Embodiments of ninth aspect of the present invention may include one or more features of the fourth, fifth or eighth aspects of the present invention or its embodiments. Similarly, embodiments of the eighth aspect of the present invention may include one or more features of the fourth, fifth or ninth aspect of the present invention or its embodiments.

According to a tenth aspect of the present invention there is provided a vessel or barge comprising an apparatus according to the first, second, third, sixth or seventh aspect of the present invention.

Embodiments of tenth aspect of the present invention may include one or more features of the first, second, third, fifth, sixth and seventh aspects of the present invention or its embodiments.

According to an eleventh aspect of the present invention there is provided an apparatus for treating ballast water comprising:
two or more ballast water inlets;
two or more treated ballast water outlets;
a filter;
a water treatment unit, wherein the filter and the water treatment unit are arranged between the ballast water inlets and the ballast water outlets; and
a flow control device, the flow control device being operable to control the flow of ballast water through each inlet and outlet.

The flow control device being operable to control the flow rate of ballast water through each inlet and outlet.

The flow control device may be operable such that the flow rates of water passing through each inlet are substantially equal. The flow control device may be operable such that the flow rates of water passing through each outlet are substantially equal.

The filter and the water treatment unit may be arranged sequentially between the ballast water inlets and the ballast water outlets.

The apparatus may further comprise a water monitoring unit, the water monitoring unit being operable to monitor at least one parameter of the water passing through the apparatus.

The apparatus may further comprise a backflush handling system connected to receive backflush liquid from the filter.

Each ballast water inlet may be associated with, or include, a control valve. The control valve may be operable to control the flow rate of water therethrough.

Each ballast water inlet may be associated with, or include, a flow meter. The flow meter may be operable to measure, or determine, the flow rate of water through the inlet and/or control valve. Each flow meter may be located downstream, or upstream, of the control valve. Each flow meter may be operable to control the operation of the control valve. Each flow meter may be operable to control the operation of the control valve such that the flow rates of water passing through each inlet and/or control valve is substantially equal. Each flow meter may be operable to automatically control the operation of the control valve. Each flow meter may be operable to automatically control the operation of the control valve such that the flow rates of water passing through each inlet and/or control valve are substantially equal.

The flow control device may comprise the one or more control valves and the one or more flow meters.

Each treated ballast water outlet may be associated with, or include, a control valve. The control valve may be operable to control the flow rate of water therethrough.

Each treated ballast water outlet may be associated with, or include, a flow meter. The flow meter may be operable to measure, or determine, the flow rate of water through the outlet and/or control valve. Each flow meter may be located downstream, or upstream, of the control valve. Each flow meter may be operable to control the operation of the control valve. Each flow meter may be operable to control the operation of the control valve such that the flow rates of water passing through each outlet and/or control valve is substantially equal. Each flow meter may be operable to automatically control the operation of the control valve. Each flow meter may be operable to automatically control the operation of the control valve such that the flow rates of water passing through each outlet and/or control valve are substantially equal.

The flow control device may comprise the one or more control valves and the one or more flow meters.

The apparatus may include two or more ballast tank return outlets. The apparatus may include a first ballast tank return outlet and a second ballast tank return outlet.

The two or more ballast tank return outlets are associated with the treated ballast water outlets.

Each ballast tank return outlet may be associated with, or include, a control valve. The control valve may be operable to control the flow rate of water therethrough.

Each ballast tank return outlet may be associated with the flow meter of the treated ballast water outlet. The flow meter may be operable to control the operation of the control valves of the treated ballast water outlet and ballast tank return outlet to select where treated water should be dispatched. The flow meter may be operable to measure, or determine, the flow rate of water through the outlet and/or control valve. Each flow meter may be located downstream, or upstream, of the control valve. Each flow meter may be operable to control the operation of the control valve. Each flow meter may be operable to control the operation of the control valve such that the flow rates of water passing through each outlet and/or control valve is substantially equal. Each flow meter may be operable to automatically control the operation of the control valve. Each flow meter may be operable to automatically control the operation of the control valve such that the flow rates of water passing through each outlet and/or control valve are substantially equal.

The flow control device may be operable such that the flow rates of water passing through each ballast tank return outlet are substantially equal.

The apparatus may further comprise a control system. The control system may be operable to control the operation of one or more, or all, of: the water treatment unit; the water monitoring unit; all valves and control valves of the apparatus; the control valves of the ballast water inlets, treated ballast water outlets and ballast return outlets; the flow control device, the flow meters of the ballast water inlets and treated ballast water outlets; the backflush handling system; the auxiliary pumping system and the incoming water analysis unit.

Embodiments of the eleventh aspect of the present invention may include one or more features of the any of the first through tenth aspects of the present invention or their embodiments.

According to a twelfth aspect of the present invention there is provided a method of treating ballast water comprising the steps of:
providing an apparatus for treating ballast water comprising;
   two or more ballast water inlets;
   two or more treated ballast water outlets;
   a filter;
   a water treatment unit, wherein the filter and the water treatment unit are arranged between the ballast water inlets and the ballast water outlets; and
   a flow control device, the flow control device being operable to control the flow of ballast water through each inlet and outlet;
passing water through the ballast water inlets;
controlling the flow of the water through the ballast water inlets with the flow control device;
filtering the water through the filter; and
treating the filtered water with the water treatment unit.

The method may include the further step of using the flow control device to substantially match the flow rates of water passing through each ballast water inlet. This step may be carried out automatically by the flow control device.

The method may include the further step of passing treated water through the treated ballast water outlets.

The method may include the further step of controlling the flow of the water through the treated ballast water outlets with the flow control device.

The method may include the further step of using the flow control device to substantially match the flow rates of water passing through each treated ballast water outlet. This step may be carried out automatically by the flow control device.

The apparatus may further comprise a water monitoring unit, the water monitoring unit being operable to monitor at least one parameter of the water passing through the apparatus. The method may comprise the further step of monitoring the treated water with the water monitoring unit.

The apparatus may further comprise a backflush handling system connected to receive backflush liquid from the filter. The method may comprise the further step of:
backflushing liquid through the filter;
passing the backflush liquid to a backflush return outlet;
or
passing the backflush liquid to the backflush treatment apparatus and passing clarified backflush liquid from the backflush treatment apparatus to the backflush return outlet;
or
passing the backflush liquid to the backflush treatment apparatus, then passing clarified backflush liquid from the backflush treatment apparatus to a point upstream of the filter; and
filtering the water through the filter; and
treating the filtered water with the water treatment unit.

Embodiments of the twelfth aspect of the present invention may include one or more features of the first through eleventh aspects of the present invention or their embodiments.

According to a thirteenth aspect of the present invention there is provided an apparatus for treating ballast water comprising:
a ballast water inlet;
a treated ballast water outlet;
a filter;
a water treatment unit, wherein the filter and the water treatment unit are arranged between the ballast water inlet and the ballast water outlet; and
a control system, the control system being operable to control the operation of the apparatus.

The control system may be operable remotely to control the operation of the apparatus. The control system may be remotely operated.

The control system may be operable to control the operation of one or more, or all, of: the water treatment unit; the water monitoring unit; all valves and control valves of the apparatus; the control valves of the ballast water inlets, treated ballast water outlets and ballast return outlets; the flow meters of the ballast water inlets and treated ballast water outlets; the backflush handling system; the auxiliary pumping system and the incoming water analysis unit.

The control system may be located remotely from the apparatus. The control system may be configured to operate the apparatus from a remote location. The control system may include a hand-held operating device. The hand-held operating device being configured to control the operation of the apparatus. The hand-held operating device, or control system, may be hard-wired to the apparatus for the operation thereof. The hand-held operating device, or control system, may be configured to operate the apparatus wirelessly. The wireless operation may be of any suitable wireless protocol communication system, including 3G, 4G etc.

Embodiments of the thirteenth aspect of the present invention may include one or more features of the first through twelfth aspects of the present invention or their embodiments.

According to a fourteenth aspect of the present invention there is provided a method of treating ballast water comprising the steps of:
providing an apparatus for treating ballast water comprising;
   a ballast water inlet;
   a treated ballast water outlet;
   a filter;
   a water treatment unit, wherein the filter and the water treatment unit are arranged between the ballast water inlet and the ballast water outlet; and
   a control system, the control system being operable to control the operation of the apparatus;
passing water through the ballast water inlet;
filtering the water through the filter;
treating the filtered water with the water treatment unit; and
controlling the operation of the apparatus with the control system.

The control system may be operable remotely to control the operation of the apparatus. The control system may be remotely operated.

The control system may be operable to control the operation of one or more, or all, of: the water treatment unit; the water monitoring unit; all valves and control valves of the apparatus; the control valves of the ballast water inlets, treated ballast water outlets and ballast return outlets; the flow meters of the ballast water inlets and treated ballast water outlets; the backflush handling system; the auxiliary pumping system and the incoming water analysis unit. The method may comprise the further step of using the control system to control the operation of one or more, or all, of: the water treatment unit; the water monitoring unit; all valves and control valves of the apparatus; the control valves of the ballast water inlets, treated ballast water outlets and ballast return outlets; the flow meters of the ballast water inlets and treated ballast water outlets; the backflush handling system; the auxiliary pumping system and the incoming water analysis unit.

The control system may be configured to operate the apparatus from a remote location. The control system may include a hand-held operating device. The hand-held operating device being configured to control the operation of the apparatus. The hand-held operating device, or control system, may be hard-wired to the apparatus for the operation thereof. The hand-held operating device, or control system, may be configured to operate the apparatus wirelessly. The wireless operation may be of any suitable wireless protocol communication system, including 3G, 4G etc.

The method may comprise the step of controlling the operation of the apparatus remotely.

Embodiments of the fourteenth aspect of the present invention may include one or more features of the first through thirteenth aspects of the present invention or their embodiments.

### BRIEF DESCRIPTION OF THE DRAWINGS

Embodiments of the invention will now be described, by way of example, with reference to the drawings, in which:

FIG. 1 is a perspective view of one form of an apparatus for treating ballast water according to the present invention;

FIG. 2 is a hydraulic circuit diagram of the apparatus of FIG. 1;

FIG. 3 is a schematic cross-section of a settling tank used in this embodiment; and

FIG. 4 is a hydraulic circuit diagram of an alternative arrangement of the apparatus of FIG. 1.

### DESCRIPTION OF PREFERRED EMBODIMENTS

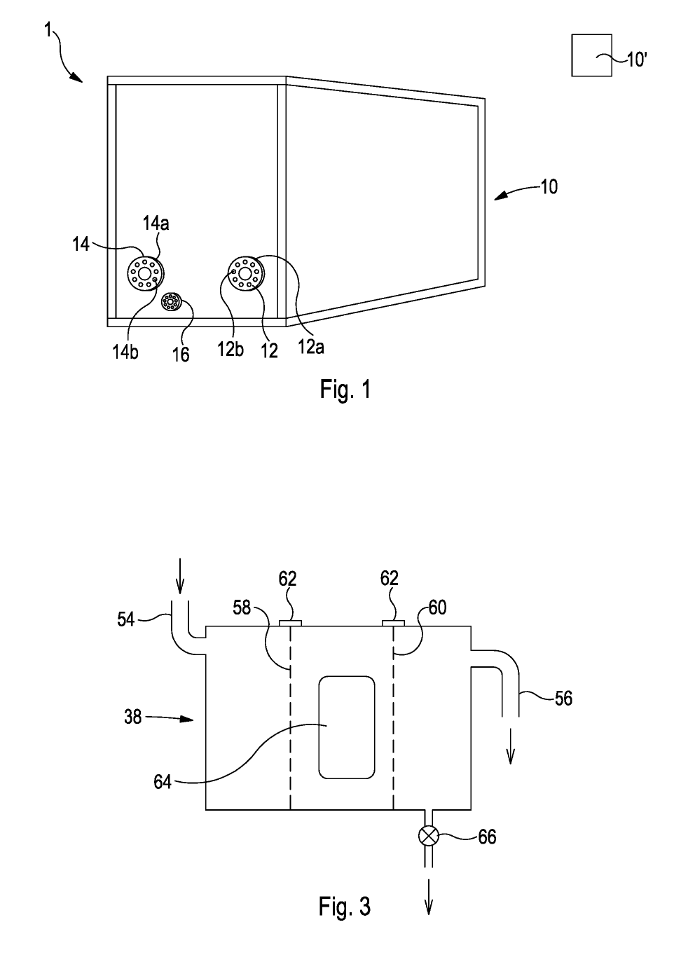

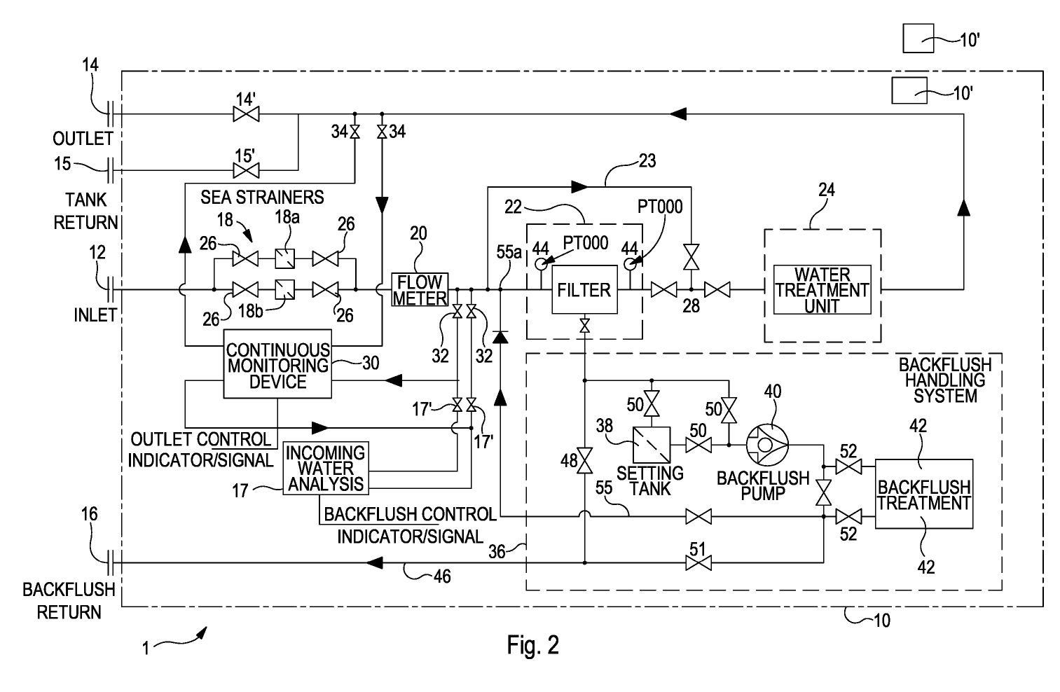

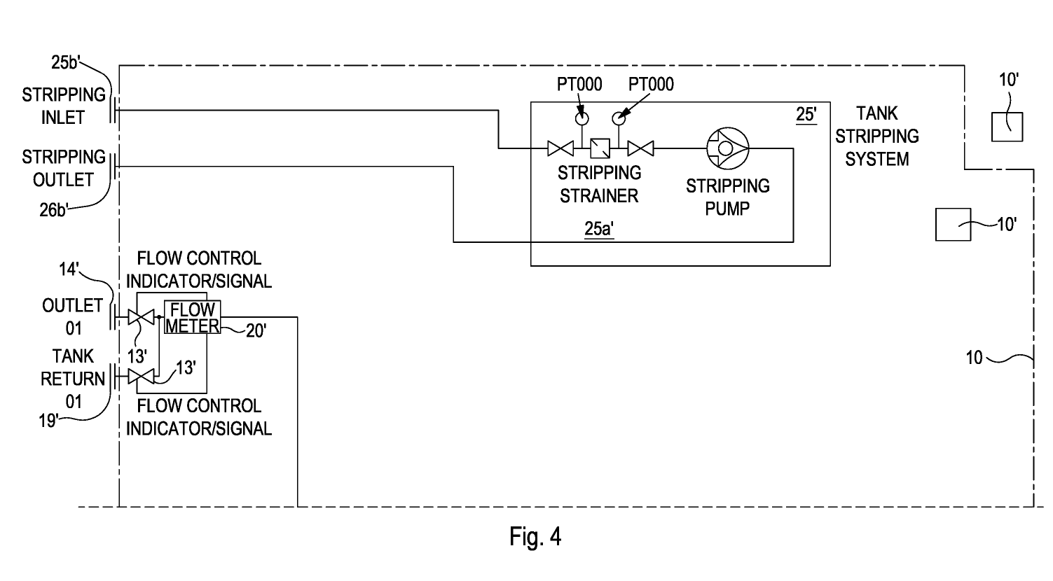

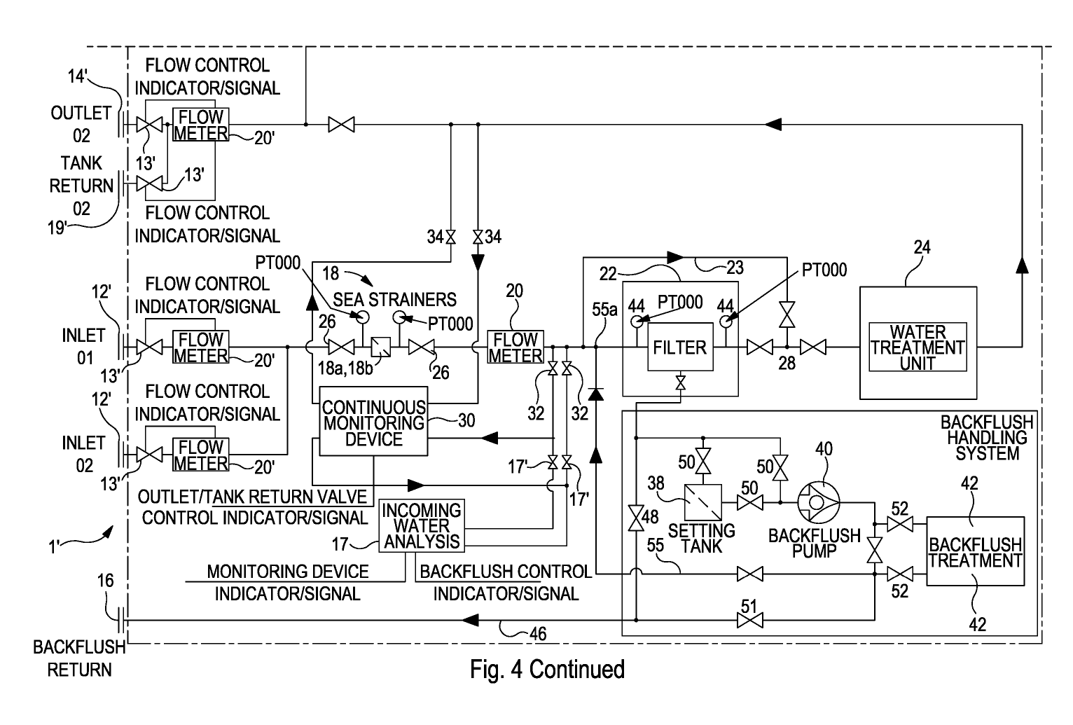

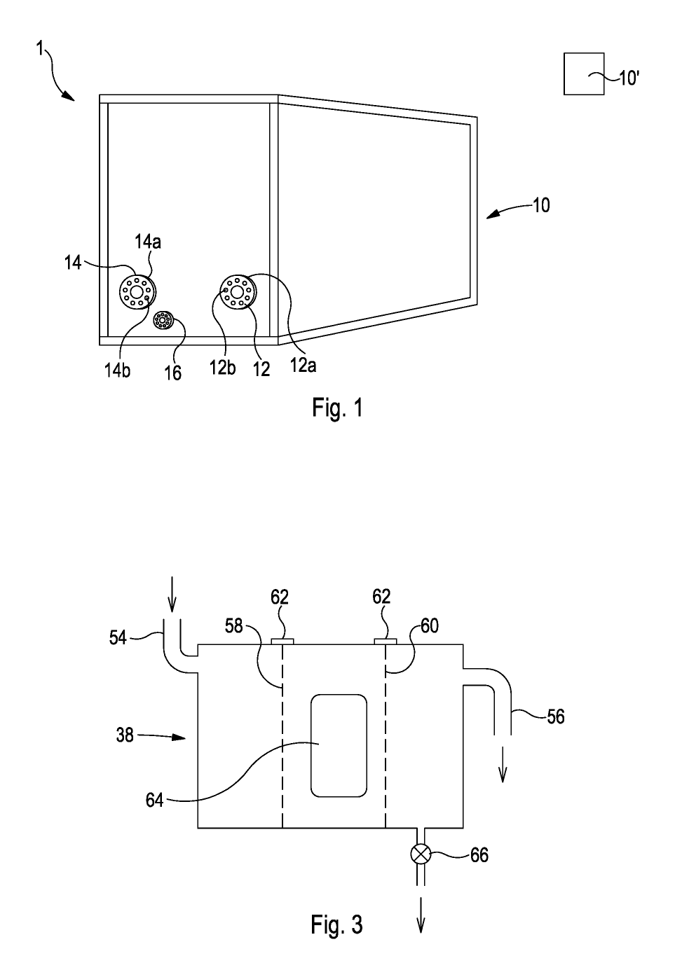

Referring to FIG. 1, the ballast water treatment apparatus 1 (an example of an apparatus for treating ballast water) of the present embodiment is mounted within a container 10 which may suitably be an ISO 20 foot high-cube container. Connections are provided at one end of the container 10 in the form of flanges 12a, 14a with bolt holes 12b, 14b. One connection 12 serves as a ballast water inlet, a second connection 14 serves as a treated water outlet (an example of a treated ballast water outlet), and the third connection 16 is an output for backflush water (an example of a backflush return outlet). The opposite end of the container 10 has connections (not seen) for electric power and compressed air.

In the embodiment illustrated and described here the apparatus 1 in the container 10 does not include a pump for handling the ballast water, or electrical or pneumatic power sources. These can all be provided by portable devices which can readily be sourced locally. This enables the treatment apparatus to be sufficiently compact to fit within a small container. However, it should be appreciated that the apparatus 1 could be provided in the container 10 with a pump for handling the ballast water, an electrical and a pneumatic power source. The apparatus 1 may also be outfitted with apparatus for connecting to either power from a barge (vessel), or a portable generator. The apparatus 1 may include an electrical distribution board (not illustrated) with a standard input socket to connect to a power source. The board would power all the components of the apparatus 1. The apparatus 1 may also include an air compressor unit to provide pneumatic air to the valves of the treatment system and monitoring system.

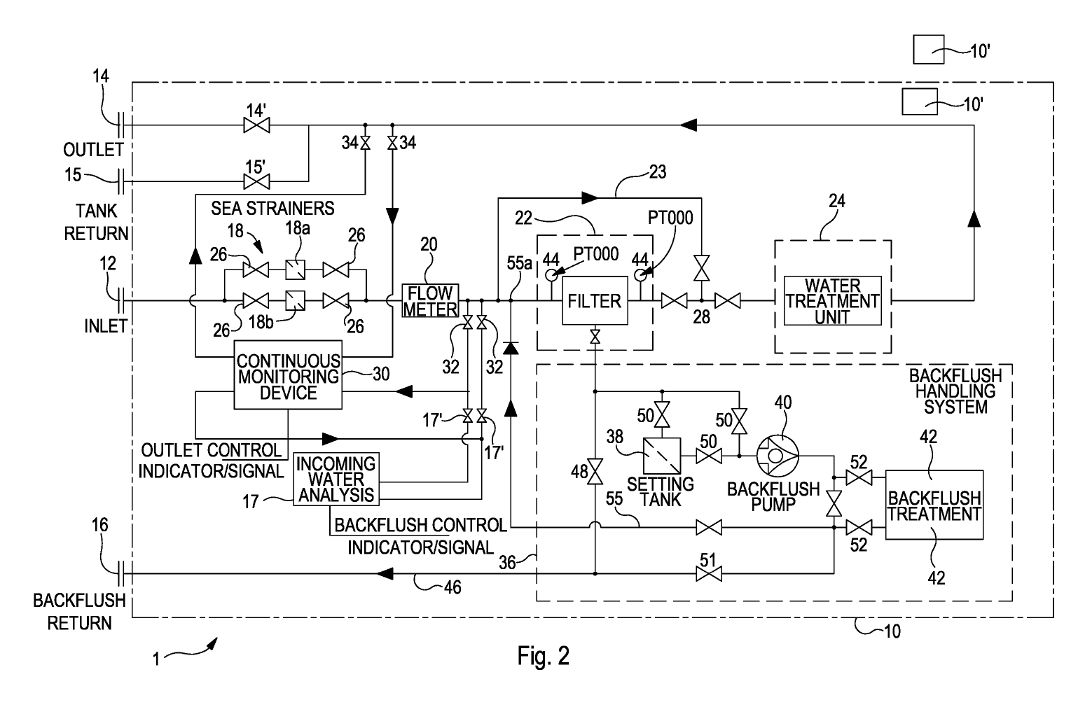

Turning to FIG. 2, the basic process flow is that water passes from the inlet 12 through inlet strainers 18, a flow meter 20, a filter unit 22 (an example of a filter), and a UV treatment unit 24 (an example of a water treatment unit) to the outlet 14 (with associated valve 14′). This flow is produced by an external pump (not shown) which may be a ship's pump or a portable pump. It should be appreciated that inlet strainers 18 may or may not be required, depending on the use of the apparatus 1. In the embodiment illustrated and described here the water treatment unit (UV treatment unit 24) is an ultraviolet water treatment unit. However, it should be appreciated that the water treatment unit may be any water treatment unit that is operable to kill or render moribund aquatic organisms or species in the ballast water. The water treatment unit may be operable to kill or render moribund aquatic organisms or species in the ballast water in accordance with legislative standards. The legislative standards may be the International Convention for Control and Management of Ships' Ballast Water and Sediments. The legislative standard may be the D-2 requirement established by the International Maritime Organisation (IMO). Examples of other water treatment units may be electro chlorination treatment units, ozone treatment units, chemical treatment units, ultrasonic treatment units and deoxygenation treatment units.

In this embodiment illustrated and described here, the filter unit 22 and UV treatment unit 24 are incorporated in a “Guardian Gold” ballast water treatment system by Hyde Marine, Inc. of Coraopolis, Pa. The filter unit 22 is a screen filter with a filter element size of 40 microns, maximum operating pressure of 6 bar, maximum operating temperature of +55° C., and a design pressure drop of 0.1-0.4 bar. In this embodiment illustrated and described here the UV treatment unit 24 is a medium pressure unit in 316 stainless steel with a maximum operating pressure of bar, maximum operating temperature of +55° C. In this embodiment illustrated and described here the UV lamp type is B3550H and lamp life 8000 hours.

The strainers 18 comprise a pair of basket sea strainers 18a and 18b with associated valves 26 which may be operated to put one strainer in circuit while the other is isolated and opened for cleaning. To this end, the strainers 18 preferably have a quick-release lid.

In the case where UV treatment without filtration is desired, as when performing a second pass to discharge previously treated ballast water, the filter unit 22 may be bypassed by operation of valves 28. The bypassed water may follow bypass line 23.

An important aspect of embodiments of the invention is the ability to carry out continuous monitoring of the quality of incoming and/or discharge water. The apparatus 1 is configured to monitor parameters of the water passing through the apparatus 1. The parameters may be linked to the “quality” of the water. The parameters may relate to aquatic organism content of the water.

A continuous monitoring unit 30 can be connected to receive a proportion of the incoming water by opening valves 32, and to receive a proportion of discharge water by opening valves 34. The water monitoring unit 30 may be operable to monitor particle size or presence of certain particles in the water. The water monitoring unit 30 may be operable to detect the presence of particles of micro-organisms. The water monitoring unit 30 may be operable to detect the amount of an aquatic organism, or aquatic organisms, present in a particular volume of water. The above are examples of parameters measured of determined by the monitoring unit 30.

The monitoring unit 30 in this embodiment is based on the single turnover fluorescence (STF) induction method of detection. Such systems are known per se, and operate by taking small samples post treatment at predetermined time intervals (typically circa 1 minute) and, using various flashing LEDs, measuring the fluorescence of cells in the water and comparing with the regulatory thresholds. In the present embodiment the apparatus 1 is modified to sample both incoming and treated water. Sample data is recorded as pairs of “before treatment” and “after treatment”. This not only provides an immediate indication of compliance with the required standard, but also gives a measure of the efficacy of the apparatus. This is an example of comparing a measured or determined parameter with a reference or predetermined parameter.

The water monitoring unit 30 is operable to sample the treated water. The water monitoring unit 30 is operable to sample the treated water and compare the at least one monitored parameter with at least one reference parameter. The at least one reference parameter may be a pre-determined discharge acceptable standard according to the International Maritime Organisation (IMO) and/or US Coast Guard (USCG).

The water monitoring unit 30 is operable to provide an indication of the comparison between the at least one monitored parameter with at least one reference parameter. The indication may be a visual indication. The indication may be a visible “pass” or “fail”, depending on how the at least one monitored parameter with at least one reference parameter. The water monitoring unit 30 is operable to compare the at least one monitored parameter with at least one reference parameter in real time. The water monitoring unit 30 also includes one or more data logging devices operable to store data relating to the monitored parameters and the comparison between the at least one reference parameter. The indication of comparison being between the at least one monitored parameter with at least one reference parameter.

The water monitoring unit 30 is operable to prevent discharge of ballast water if the at least one monitored parameter of the ballast water does not meet pre-determined standards, or certain compliance conditions. The apparatus 1 is configured such that ballast water that does not meet pre-determined standards, or certain compliance conditions, is recirculated for retreatment. In this arrangement the ballast water may be recirculated in the apparatus 1 until the ballast water meets pre-determined standards, or certain compliance conditions. In this arrangement the apparatus 1 includes one or more flow paths, or pipework, that redirects ballast water that does not meet pre-determined standards, or certain compliance conditions, back to the ballast tank for retreatment. The ballast tank return line (an example of a ballast tank return outlet) is indicated at reference 15 in FIG. 2, with associated valve 15′. An incoming water analysis unit 17 is also provided, with associated valves 17′. The incoming water analysis unit 17 is operable to control the backflushing capability of the apparatus 1, as described below. The incoming water analysis unit 17 may also be configured to provide the water monitoring unit 30 with information relating to the quality of coming into the apparatus before it is treated. This increases the accuracy of the water monitoring unit 30 by providing one or more predetermined parameters of the water (a baseline water quality) to thereto before treatment.

One suitable system for forming the basis of the monitoring unit 30 is the variable fluorometer supplied by YSI Incorporated (Xylem group) of Yellow Springs, Ohio.

The monitoring unit 30 includes a memory on which the monitoring data can be logged and held for subsequent review or analysis. This simplifies the process of demonstrating compliance with regulatory requirements. Any suitable form of memory may be used, suitably a solid state memory such as an SD card. Preferably, the data may also be transferred by downloading to a memory stick or the like.

The availability of water quality information in close to, or in, real time also allows the system to be operated in such a way that, if the discharge water fails to reach the required standard, it can be returned to its source (for example, a ballast tank) and recycled for further treatment. The process of recycling the ballast water if it is not suitable for discharge may be automated.

The filter unit 22 as is conventional detects when the filter elements are becoming clogged and operates to clean them by backflushing. The need for this is typically determined by detecting excessive pressure drop across the filter unit 22. Pressure gauges 44 may be associated with the filter unit 22 for additional monitoring. An internal pump (not illustrated) forces debris from the filter elements of the filter unit 22, the debris passing by gravity to discharge line 46. In conventional operation, the backwash liquid would simply be discharged overboard. This may be acceptable when taking on ballast water, as the debris is being returned to its origin. The present embodiment can operate in this mode by opening discharge valve 48.

In other situations, however, it may be undesirable to discharge the material removed from the filter elements of the filter unit 22, for example when discharging water which is not definitively known to have been filtered when loaded. For this reason, the present embodiment also includes a backflush handling system generally designated at 36, which comprises a settling tank 38, a backflush pump 40, backflush strainers 42, and associated valves 52. The backflush pump 40 may conveniently be a centrifugal pump, and should be rated at similar capacity to the maximum permitted backflush flow rate of the main mechanical filter. The settling tank 38, a backflush pump 40, backflush strainers 42, and associated valves 52 are an example of a backflush treatment apparatus. Although in the embodiment illustrated and described here the backflush handling system 36 is described as having a backflush treatment apparatus that comprises a settling tank 38, a backflush pump 40, backflush strainers 42, and associated valves 52, it should be appreciated that the backflush handling system 36 may additionally, or alternatively, comprise a backflush treatment apparatus that may be, or comprise, at least one centrifugal separator, at least one cyclonic separator or at least one clarifier. Where centrifugal separators, cyclonic separators or clarifiers are used these devices may separate the sediment from the water and drain out the sediment to a sediment storage vessel, or the like (e.g. a sludge tank). The clean, or clarified, water may be reintroduced to the main ballast flow for retreatment. The clean, or clarified, water may be reintroduced to the main ballast flow for retreatment via return line 55. As illustrated in FIG. 2, the return line 55 goes from the backflush handling system 36 to a point (recycled point) 55a upstream of the filter 22.

When backflushing occurs, the discharge valve 48 may be closed and the backflush residue allowed to pass to the settling tank 38 by gravity. The settling tank 38 is described in greater detail below. Much of the debris or residue will be trapped in the settling tank 38, which can subsequently be isolated by valves 50 to allow the debris to be removed and disposed of safely. The liquid in the settling tank 38 can be moved by the backflush pump 40 in two ways. First it can be discharged overboard via discharge valve 51. Alternatively, it can be filtered and recycled via the backflush strainers 42. Valves 52 allow selected ones of the backflush strainers 42 to be brought into operation or isolated while this is happening. It is preferred that two backflush strainers will have sufficient capacity to handle the flow, allowing the other two to be cleaned. The backflush strainers 42 should have a mesh size similar to the main filter unit 22 to ensure that any sediment reintroduced to the main flow will no longer clog the main filter 22.

FIG. 3 shows the settling tank 38 in more detail. The settling tank 38 has a high level input 54 (an example of an inlet) at one end, and a high level discharge 56 (an example of an outlet) at the other end. These are separated by filter screens 58 and 60 of decreasing mesh size. Quick release covers 62 on the top of the tank allow easy access for removing and cleaning the screens 58, 60. A door 64 in one side of the tank allows access for removing sludge, and a drain valve 66 facilitates final cleaning of the settling tank 38.

The operation of the backflush handling system 36 may be dependent upon a sensor-derived measurement of at least one parameter of the incoming ballast water. The measurement of the at least one parameter of the incoming ballast water may be obtained by an in-line sensor (not illustrated), which may be a dissolved organic matter sensor, a turbidity sensor, a UV transmittance sensor, or a water sedimentation sensor. The at least one parameter may be a measurement of the quality of the water. The quality of the water measurement may be determined by the amount of aquatic organisms (of a certain size and/or type) contained therein.

The operation of the backflush handling system 36 may be an automated operation based on the sensor-derived measurement of the at least one parameter of the incoming ballast water.

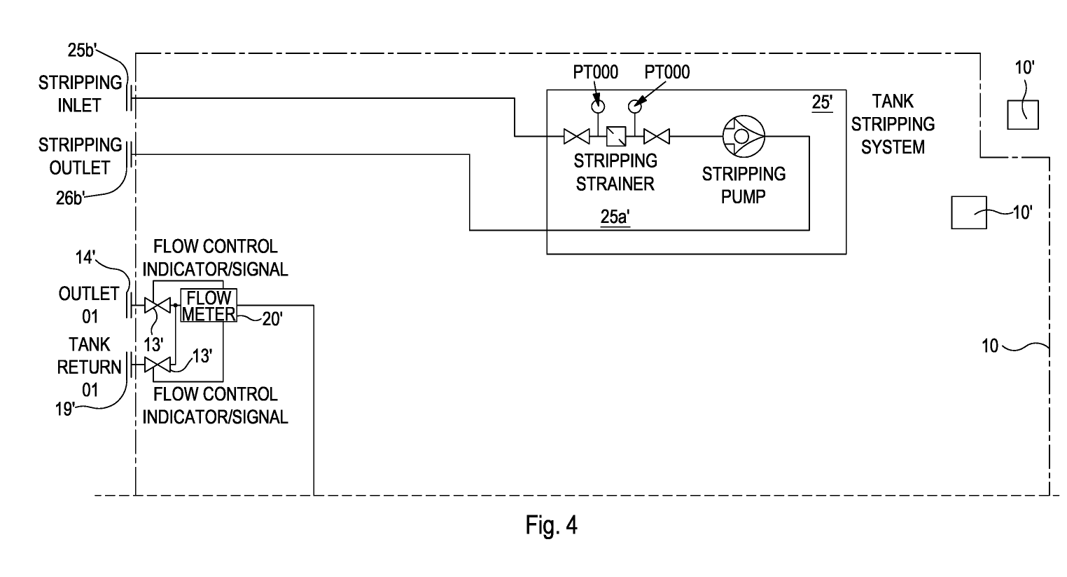

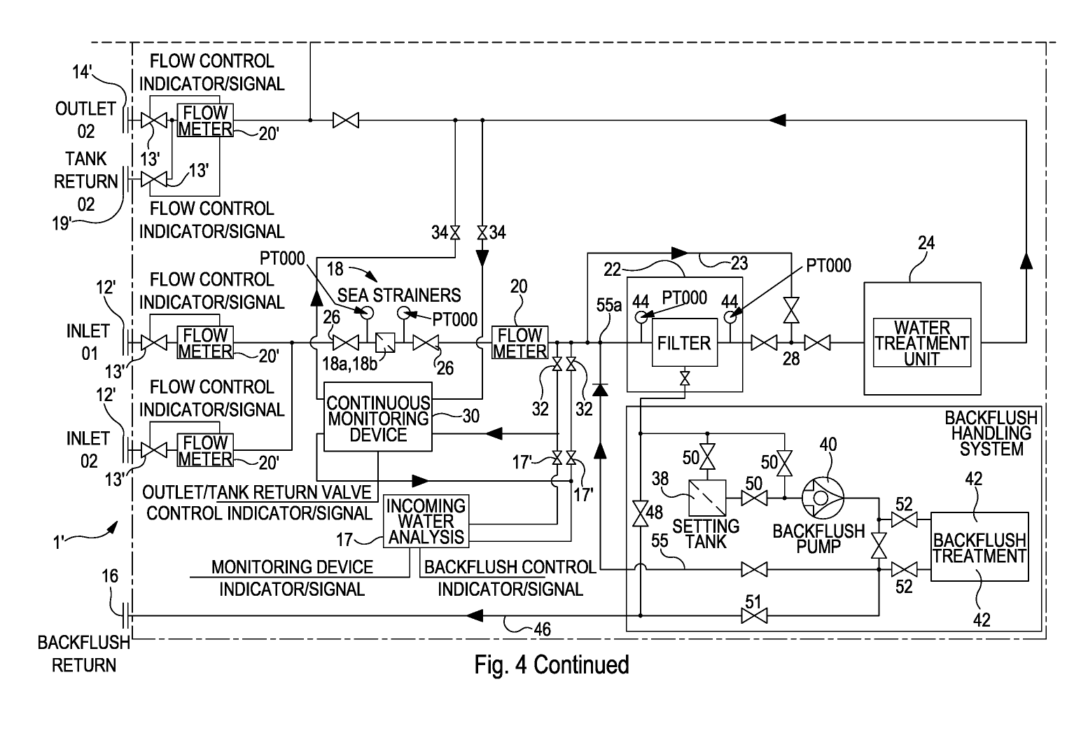

Referring to FIG. 4, an alternative embodiment of the ballast water treatment apparatus 1′ is illustrated. The arrangement of the ballast water treatment apparatus 1′ of FIG. 2 is very similar to the arrangement of the ballast water treatment apparatus 1 of FIG. 1, with the following differences. Components and features that are the same between each embodiment have the same reference number in the accompany figures.

In the embodiment illustrated and described here the ballast water treatment apparatus 1′ includes two ballast water inlets 12′, two treated ballast water outlets 14′ and two ballast tank return outlets 19′.

The two ballast water inlets 12′ join together at point 12a′, such that the inlets lead to a single flow path.

As illustrated in FIG. 4, each ballast water inlet 12′ is associated with, or include, a control valve 13′. The control valve 13′ is operable to control the flow rate of water through the ballast water inlet 12′. Each ballast water inlet 12′ also includes a flow meter 20′. Each flow meter 20′ is operable to measure, or determine, the flow rate of water through the inlet 12′ and/or control valve 13′. Each flow meter 20′ is located downstream, or upstream, of the control valve 13′.

Each flow meter 20′ is also operable to control the operation of the control valve 13′. Each flow meter 20′ may be operable to control the operation of the control valve 13′ such that the flow rates of water passing through each inlet 12′ and/or control valve 13′ is substantially equal. That is, the flow meters 20′ are operable to adjust the flow rates of water flowing through each inlet 12′ and/or control valve 13′ such that their flow rates are substantially equal.

This may be beneficial in situations where vessels, such as heavy lift barges, are required to discharge ballast water from two tanks concurrently, using two individual ballast pumps. The tanks have to be discharged at the same rate for stability reasons. However, two different pumps and varying hose layouts means proper balancing would never be achieved. Providing two or more ballast water inlets 12′ where the flow rate of water therethrough is controlled by the operation of the flow meters 20′ and control valves 13′ ensures that the flow rates of water passing through the inlets 12′ can be matched, such that the tanks, and vessel, are properly balanced.

The operation of each flow meter 20′ and control valve 13′ may be automatic. That is each flow meter 20′ may be operable to automatically control the operation of the control valve 13′. The apparatus 1′ may therefore be operable to automatically adjust the flow rates to ensure a balanced operation.

As illustrated in FIG. 4, each treated ballast water outlet 14′ is associated with, or include, a control valve 13′. The control valve 13′ is operable to control the flow rate of water through the treated ballast water outlet 14′. Each treated ballast water outlet 14′ also includes a flow meter 20′. Each flow meter 20′ is operable to measure, or determine, the flow rate of water through the outlet 14′ and/or control valve 13′. Each flow meter 20′ is located downstream, or upstream, of the control valve 13′.

Again, each flow meter 20′ is also operable to control the operation of the control valve 13′. Each flow meter 20′ may be operable to control the operation of the control valve 13′ such that the flow rates of water passing through each outlet 14′ and/or control valve 13′ is substantially equal. That is, the flow meters 20′ are operable to adjust the flow rates of water flowing through each outlet 14′ and/or control valve 13′ such that their flow rates are substantially equal.

Again, this is beneficial when treated ballast water is loaded to heavy lift barges to ensure that proper balancing is achieved.

Providing two or more ballast water outlets 14′ where the flow rate of water therethrough is controlled by the operation of the flow meters 20′ and control valves 13′ ensures that the flow rates of water passing through the outlets 14′ can be matched, such that the tanks, and vessel, are properly balanced. Again, the operation of each flow meter 20′ and control valve 13′ may be automatic. That is each flow meter 20′ may be operable to automatically control the operation of the control valve 13′. The apparatus 1′ may therefore be operable to automatically adjust the flow rates to ensure a balanced operation.

As illustrated in FIG. 4, the ballast tank return outlets 19′ are associated with the treated ballast water outlets 14′. Each ballast tank return outlet 19′ is associated with, or include, a control valve 13′. The control valve 13′ is operable to control the flow rate of water therethrough.

Each ballast tank return outlet 19′ is associated with the flow meter 20′ of the treated ballast water outlet 14′. The flow meter 20′ is operable to control the operation of the control valves 13′ of the treated ballast water outlet 14′ and ballast tank return outlet 19′ to select where treated water should be dispatched.

Again, the flow meter 20′ is operable to measure, or determine, the flow rate of water through the outlet 19′ and/or control valve 13′ and control the flow rates, as described above.

The apparatus 1′ also includes a stripping pump 25′ (an example of an auxiliary pumping system). The stripping pumping 25′ is operable to remove residual ballast water that cannot otherwise be removed from a ballast tank by pumps normally associated with ships, barges etc. A typical pump that could be used in this stripping pump system is a diaphragm pump, a low profile “puddle pump” or potentially a submersible pump, or the like.

The stripping pump 25′ also includes a strainer 25a′ and control valves 13′. The apparatus 1′ further comprises a stripping pump inlet 25b′ and outlet 26b′. The stripping pump inlet 25b′ and outlet 26b′ being configured to be connectable to the stripping pump 25′. The stripping pump inlet 25b′ is configured to be connectable to a ballast tank.

Other than the operation of the control valves 13′ and flow meters 20′, the method of operating the apparatus 1′ is substantially identical to the operation of the apparatus 1.

Each apparatus 1 and 1′ further comprise a control system 10′. The control system 10′ is operable to control the operation of one or more, or all, of: the water treatment unit; the water monitoring unit; all valves and control valves of the apparatus; the control valves of the ballast water inlets, treated ballast water outlets and ballast return outlets; the flow meters of the ballast water inlets and treated ballast water outlets; the backflush handling system; the auxiliary pumping system and the incoming water analysis unit.

The control system 10′ may be located with the apparatus 1, 1′. Alternatively, the control system 10′ may be located remotely from the apparatus 1, 1′. The control system 10′ may be configured to operate the apparatus from a remote location. The control system may include a hand-held operating device. The hand-held operating device being configured to control the operation of the apparatus. The hand-held operating device, or control system, may be hard-wired to the apparatus for the operation thereof. The hand-held operating device, or control system, may be configured to operate the apparatus wirelessly. The wireless operation may be of any suitable wireless protocol communication system, including 3G, 4G etc.

The invention thus provides a readily portable apparatus for treatment of ballast water, which can be used flexibly to deal with various situations which may arise.

Modifications and improvements may be made to the above without departing from the scope of the present invention. For example, although the apparatus 1, 1′ has been illustrated and described above as including both a water monitoring unit 30 and a backflush handling system 36, it should be appreciated that the apparatus 1, 1′ may have only one of these. That is, it should be appreciated that in one embodiment of the invention the apparatus 1, 1′ includes a water monitoring unit 30, but no backflush handling system 36, and in another embodiment of the invention the apparatus 1, 1′ includes a backflush handling system 36, but no water monitoring unit 30. Another embodiment is of course that the apparatus 1, 1′ includes both a water monitoring unit 30 and a backflush handling system 36.

Furthermore, although the apparatus 1, 1′ has been illustrated and described above as comprising an ultraviolet (UV) treatment unit, it should be appreciated that the water treatment unit may be an alternative water treatment unit. Each water treatment unit may be operable to kill or render moribund aquatic organisms or species in the ballast water. The water treatment unit may be operable to kill or render moribund aquatic organisms or species in the ballast water. The water treatment unit may be operable to kill or render moribund aquatic organisms or species in the ballast water in accordance with legislative standards. The legislative standards may be the International Convention for Control and Management of Ships' Ballast Water and Sediments. The legislative standard may be the D-2 requirement established by the International Maritime Organisation (IMO).

The alternative water treatment units may be one or more of the following: an electro chlorination treatment unit, an ozone treatment unit, a chemical treatment unit, an ultrasonic treatment unit, or a deoxygenation treatment unit. The water treatment unit may comprise a combination of any two or more of an ultraviolet (UV) treatment unit, an electro chlorination treatment unit, an ozone treatment unit, a chemical treatment unit, an ultrasonic treatment unit and a deoxygenation treatment unit.

Also, although the apparatus 1, 1′ has been illustrated and described above as comprising strainers 18 at the ballast water inlet 12, it should be appreciated that inlet strainers 18 may or may not be required, depending on the use of the apparatus 1, 1′ and the availability of other strainers on a vessel, for example.

Furthermore, the term “clarified” may be considered as “filtered” in the context of the above description.

Also, although the method has been described above as operating the backflush handling system to backflush liquid:
(i) directly to the backflush return outlet, or
(ii) to the backflush treatment apparatus, with clarified liquid from the backflush treatment apparatus then being passed to the backflush return outlet, or
(iii) to the backflush treatment apparatus, with clarified liquid from the backflush treatment apparatus then being recycled to a point upstream of the filter,
   it should be appreciated that the method may comprise the step of carrying out any combination of steps (i), (ii) or (iii) above.

1-43. (canceled)

44. The apparatus of claim 138, wherein the backflush handling system comprises a backflush treatment apparatus, the backflush treatment apparatus being operable to separate sediment from the water.

45-131. (canceled)

132. An apparatus for treating ballast water comprising:
two or more ballast water inlets;
two or more treated ballast water outlets;
a filter;
a water treatment unit, wherein the filter and the water treatment unit are arranged between the ballast water inlets and the ballast water outlets; and
a flow control device, the flow control device being operable to control the flow of ballast water through each inlet and outlet.

133. (canceled)

134. The apparatus of claim 132, wherein the flow control device is operable such that the flow rates of water passing through each inlet may be substantially equal.

135. The apparatus of claim 132, wherein the flow control device is operable such that the flow rates of water passing through each outlet may be substantially equal.

136. (canceled)

137. The apparatus of claim 132, wherein the apparatus further comprises a water monitoring unit, the water monitoring unit being operable to monitor at least one parameter of the water passing through the apparatus.

138. The apparatus of claim 132, wherein the apparatus further comprises a backflush handling system connected to receive backflush liquid from the filter.

139. The apparatus of claim 132, wherein each ballast water inlet is associated with, or includes, a control valve, the control valve is operable to control the flow rate of water therethrough.

140. The apparatus of claim 139, wherein each ballast water inlet is associated with, or includes, a flow meter, the flow meter being operable to measure, or determine, the flow rate of water through the inlet and/or control valve.

141. The apparatus of claim 140, wherein each flow meter is operable to control the operation of the control valve.

142. The apparatus of claim 141, wherein each flow meter is operable to control the operation of the control valve such that the flow rates of water passing through each inlet and/or control valve may be substantially equal.

143. (canceled)

144. The apparatus of claim 132, wherein each treated ballast water outlet is associated with, or includes, a control valve, the control valve being operable to control the flow rate of water therethrough.

145. The apparatus of claim 144, wherein each treated ballast water outlet is associated with, or includes, a flow meter, the flow meter being operable to measure, or determine, the flow rate of water through the outlet and/or control valve.

146. The apparatus of claim 145, wherein each flow meter is operable to control the operation of the control valve.

147. The apparatus of claim 146, wherein each flow meter is operable to control the operation of the control valve such that the flow rates of water passing through each outlet and/or control valve may be substantially equal.

148. (canceled)

149. The apparatus of claim 132, wherein the apparatus includes two or more ballast tank return outlets, wherein the ballast tank return outlets are associated with the treated ballast water outlets.

150. (canceled)

151. The apparatus of claim 149, wherein each ballast tank return outlet is associated with, or includes, a control valve, the control valve being operable to control the flow rate of water therethrough.

152. The apparatus of claim 151, wherein each ballast tank return outlet is associated with the flow meter of the treated ballast water outlet, the flow meter being operable to control the operation of the control valves of the treated ballast water outlet and ballast tank return outlet to select where treated water should be directed.

153. The apparatus of claim 152, wherein each flow meter is operable to control the operation of the control valve such that the flow rates of water passing through each outlet and/or control valve may be substantially equal.

154. The apparatus of claim 132, wherein the apparatus further comprises an auxiliary pumping system, the auxiliary pumping system being connectable to a ballast tank.

155-157. (canceled)

158. A method of treating ballast water comprising the steps of:
providing an apparatus for treating ballast water comprising;
two or more ballast water inlets;
two or more treated ballast water outlets;
a filter;
a water treatment unit, wherein the filter and the water treatment unit are arranged between the ballast water inlets and the ballast water outlets; and
a flow control device, the flow control device being operable to control the flow of ballast water through each inlet and outlet;
passing water through the ballast water inlets;
controlling the flow of the water through the ballast water inlets with the flow control device;
filtering the water through the filter; and
treating the filtered water with the water treatment unit.

159-176. (canceled)
